(19) United States
(12) Patent Application Publication
(10) Pub. No.: US 2024/0375299 A1
(43) Pub. Date: Nov. 14, 2024

(54) ROBOTIC DIGIT FOR ROBOTIC HAND

(71) Applicant: Sanctuary Cognitive Systems Corporation, Vancouver (CA)

(72) Inventors: Connor Richard Shannon, Vancouver (CA); Matthew Hill, Vancouver (CA); Richard Bos, Vancouver (CA); Joshua Lee, Burnaby (CA)

(21) Appl. No.: 18/658,459

(22) Filed: May 8, 2024

Related U.S. Application Data
(60) Provisional application No. 63/464,758, filed on May 8, 2023.

(51) Int. Cl. B25J 15/08

(52) U.S. Cl. CPC B25J 15/08

(57) ABSTRACT

A robotic digit includes a digit base frame, a joint head coupled to the digit base frame, and an articulated digit body coupled to the joint head. A first actuator and a second actuator are mounted to the digit base frame. The first actuator includes a first actuator output coupled to the joint head by a first mechanical linkage. The first actuator output causes a first relative movement between the joint head and the digit base frame through the first mechanical linkage. The second actuator has second actuator output coupled to the joint head. The second output causes a second relative movement between the joint head and the digit base frame that is different from the first relative movement through the second mechanical linkage.

### CROSS-REFERENCE TO RELATED APPLICATIONS

This application claims the benefit of U.S. Provisional Application No. 63/464,758 filed May 8, 2023, the content of which is incorporated herein by reference.

### FIELD

The field generally relates to robotic structures and particularly to mechanical digits for robotic hands.

### BACKGROUND

Robots are machines that can sense their environments and perform tasks autonomously or semi-autonomously or via teleoperation. A humanoid robot is a robot or machine having an appearance and/or character resembling that of a human. Humanoid robots can be designed to function as team members with humans in diverse applications, such as construction, manufacturing, monitoring, exploration, learning, and entertainment. Humanoid robots can be particularly advantageous in substituting for humans in environments that may be dangerous to humans or uninhabitable by humans.

Robots typically have robotic hands (also called end effectors) for interaction with an environment. Some robotic hands have robotic digits that can mimic human fingers. The robotic digits can include joints having the functionalities of joints in human hands (such as knuckles). The complexity of the tasks that can be performed with such robotic hands can depend on the degrees of freedom provided by the joints and the extent to which the movement of the joints can be accurately and reliably controlled.

### SUMMARY

Disclosed herein are examples of a robotic digit with one or more functionalities associated with a humanoid thumb. The robotic digit can be integrated into a robotic hand.

In a representative example, a robotic digit includes a digit base frame, a joint head, an articulated digit body movably coupled to the joint head, a first actuator mounted to the digit base frame, the first actuator having a first actuator output coupled to the joint head by a first mechanical linkage, a second actuator mounted to the digit base frame, the second actuator having a second actuator output coupled to the joint head. The first actuator output causes a first relative movement between the joint head and the digit base frame through the first mechanical linkage. The second actuator output causes a second relative movement between the joint head and the digit base frame that is different from the first relative movement through the second mechanical linkage.

In a representative example, a robotic digit includes a digit base frame, a first actuator coupled to the digit base frame, the first actuator having a first actuator output shaft, a second actuator coupled to the digit base frame, the second actuator having a second actuator output shaft, a joint head, a digit body movably coupled to the joint head, a first output member coupled to the joint head, and a second output member coupled to the joint head. A first straight line motion linkage couples the first actuator output shaft to the first output member. A linear displacement of the first actuator output shaft causes a first rotational movement of the joint head through the straight line motion linkage. A second straight line motion linkage couples the second actuator output shaft to the second output member. A linear displacement of the second actuator output shaft causes a second rotational movement of the joint head through the second straight line motion linkage. The second rotational movement is different from the first rotational movement.

### BRIEF DESCRIPTION OF THE DRAWINGS

FIG. 1 is a perspective view of a robotic digit including a digit base and a digit body coupled to the digit base by a CMC joint.

FIG. 2A is a perspective view of a subassembly including the digit base and carpometacarpal (CMC) joint shown in FIG. 1.

FIG. 2B is a perspective view of the subassembly shown in FIG. 2B taken from an opposite side.

FIG. 2C is a cutaway view of the subassembly shown in FIG. 2A.

FIG. 2D is another perspective view of the subassembly shown in FIG. 2A with a portion of the CMC joint removed.

FIG. 2E is a perspective view of the subassembly shown in FIG. 2D taken from an opposite side.

FIG. 2F is another cutaway view of the subassembly shown in FIG. 2A at a different cutting plane compared to the cutaway view shown in FIG. 2C.

FIG. 2G is a side elevation view of the subassembly shown in FIG. 2A with the CMC joint in a neutral position.

FIGS. 2H and 2I illustrate opposition movement of a CMC joint head by actuation of a first mechanical linkage of the CMC joint.

FIG. 2J is a perspective view of the subassembly shown in FIG. 2A with a portion of the CMC joint removed.

FIG. 2K is a side elevation view of the subassembly shown in FIG. 2A with the CMC joint in a neutral position.

FIGS. 2L and 2M illustrate abduction movement of the CMC joint head by actuation of a second mechanical linkage of the CMC joint.

FIG. 3A is a perspective view of a subassembly including the CMC joint head and the digit body of the robotic digit shown in FIG. 1.

FIG. 3B is a perspective view of a metacarpal of the digit body shown in FIG. 3A.

FIG. 3C is a cutaway view of the subassembly shown in FIG. 3A.

FIG. 3D is a cutaway view of the subassembly shown in FIG. 3A from a different cutting plane compared to the cutaway view shown in FIG. 3C.

FIG. 3E is a perspective view of a proximal phalanx of the digit body shown in FIG. 3A.

FIG. 3F is another perspective view of the proximal phalanx shown in FIG. 3E.

FIG. 3G is a cutaway view of the subassembly shown in FIG. 3A.

FIG. 3H is a portion of the subassembly shown in FIG. 3A including the metacarpal and proximal phalanx.

FIG. 3I is another perspective view of the subassembly shown in FIG. 3H.

FIG. 3J is a cutaway view of the subassembly shown in FIGS. 3H and 3I.

FIG. 3K is a perspective view of a distal phalanx of the digit body shown in FIG. 3A.

FIG. 3L is a portion of the subassembly shown in FIG. 3A including the proximal phalanx and the distal phalanx.

FIG. 3M is a cutaway view of the subassembly shown in FIG. 3L.

FIG. 3N is a cutaway view of the robotic digit of FIG. 1 after actuation of an opposition degree of freedom (DOF) at the CMC joint of the robotic digit.

FIG. 3O is a cutaway view of the robotic digit of FIG. 1 after actuation of an abduction DOF at the CMC joint of the robotic digit.

FIG. 3P is a cutaway view of the robotic digit of FIG. 1 after actuation of both an opposition DOF and an abduction DOF at the CMC joint of the robotic digit.

FIG. 4A is a perspective view of a robotic hand including the robotic digit shown in FIG. 1 as a first robotic digit.

FIG. 4B is a portion of the robotic hand including the first robotic digit and the second robotic digit shown in FIG. 4A with the first robotic digit rotated by actuation of an opposition DOF.

FIG. 4B is a portion of the robotic hand including the first robotic digit and the second robotic digit shown in FIG. 4A after actuation of an opposition DOF at the CMC joint of the first robotic digit.

FIG. 4C is a portion of the robotic hand including the first robotic digit and the second robotic digit shown in FIG. 4A after actuation of an abduction DOF at the CMC joint of the first robotic digit.

FIG. 4D shows the subassembly of FIG. 4B after actuation of a flexion DOF at a metacarpophalangeal (MCP) joint of the first robotic digit.

FIG. 4E shows the subassembly of FIG. 4D after actuation of an opposition DOF at the CMC joint.

FIG. 5 is a cross-section view of a tube spring.

FIG. 6A is a perspective view of a robotic digit including a digit base and a digit body coupled to the digit base by a CMC joint.

FIG. 6B shows the robotic digit of FIG. 6A with a portion of the digit base removed.

FIG. 7A is a perspective view of a subassembly including the digit base and the CMC joint shown in FIG. 6A.

FIG. 7B is a bottom view of the subassembly shown in FIG. 7A.

FIG. 7C is a perspective cross-section of the subassembly shown in FIG. 7A.

FIG. 7D is a perspective cross-section of the subassembly shown in FIG. 7A.

FIG. 7E is a perspective bottom view of the subassembly shown in FIG. 7A.

FIGS. 7F-7H illustrate a straight-line linkage using abduction components of the subassembly shown in FIG. 7A.

FIG. 7I is a perspective view of the subassembly shown in FIG. 7A with a portion of the digit base and CMC joint removed.

FIG. 7J is a partial cutaway section of the subassembly shown in FIG. 7I.

FIGS. 7K-7M illustrate a straight-line linkage using opposition components of the subassembly shown in FIG. 7A.

FIGS. 8A-8E show different configurations of the robotic digit shown in FIG. 6A based on different positions of the actuators that control the CMC joint.

FIG. 9 is a rear view of the digit body of the robotic digit shown in FIG. 6A.

### DETAILED DESCRIPTION

### General Considerations

For the purpose of this description, certain specific details are set forth herein in order to provide a thorough understanding of disclosed technology. In some cases, as will be recognized by one skilled in the art, the disclosed technology may be practiced without one or more of these specific details, or may be practiced with other methods, structures, and materials not specifically disclosed herein. In some instances, well-known structures and/or processes associated with robots have been omitted to avoid obscuring novel and non-obvious aspects of the disclosed technology.

All the examples of the disclosed technology described herein and shown in the drawings may be combined without any restrictions to form any number of combinations, unless the context clearly dictates otherwise, such as if the proposed combination involves elements that are incompatible or mutually exclusive. The sequential order of the acts in any process described herein may be rearranged, unless the context clearly dictates otherwise, such as if one act or operation requests the result of another act or operation as input.

In the interest of conciseness, and for the sake of continuity in the description, same or similar reference characters may be used for same or similar elements in different figures, and description of an element in one figure will be deemed to carry over when the element appears in other figures with the same or similar reference character, unless stated otherwise. In some cases, the term “corresponding to” may be used to describe correspondence between elements of different figures. In an example usage, when an element in a first figure is described as corresponding to another element in a second figure, the element in the first figure is deemed to have the characteristics of the other element in the second figure, and vice versa, unless stated otherwise.

The word “comprise” and derivatives thereof, such as “comprises” and “comprising”, are to be construed in an open, inclusive sense, that is, as “including, but not limited to”. The singular forms “a”, “an”, “at least one”, and “the” include plural referents, unless the context dictates otherwise. The term “and/or”, when used between the last two elements of a list of elements, means any one or more of the listed elements. The term “or” is generally employed in its broadest sense, that is, as meaning “and/or”, unless the context clearly dictates otherwise. When used to describe a range of dimensions, the phrase “between X and Y” represents a range that includes X and Y. As used herein, an “apparatus” may refer to any individual device, collection of devices, part of a device, or collections of parts of devices.

The term “coupled” without a qualifier generally means physically coupled or lined and does not exclude the presence of intermediate elements between the coupled elements absent specific contrary language. The term “plurality” or “plural” when used together with an element means two or more of the element. Directions and other relative references (e.g., inner and outer, upper and lower, above and below, and left and right) may be used to facilitate discussion of the drawings and principles but are not intended to be limiting.

The headings and Abstract are provided for convenience only and are not intended, and should not be construed, to interpret the scope or meaning of the disclosed technology.

### Example I—Overview

Described herein is a robotic digit that can emulate movements and poses of a humanoid finger. In particular, the robotic digit includes elements that can approximate a form factor and degrees of freedom of a humanoid thumb. The robotic digit can be integrated into a robotic hand or with other robotic hand technologies, such as described in, for example, U.S. patent application Ser. Nos. 18/126,343 and 18/126,345 (“Systems, Devices, and Methods for a Robotic Digit and Determining Motions and Positions Thereof”) and U.S. Provisional Application No. 63/342,414 (“Systems, Devices, and Methods for a Robotic Joint”), the contents of which are incorporated herein by reference.

### Example II—Robotic Digit

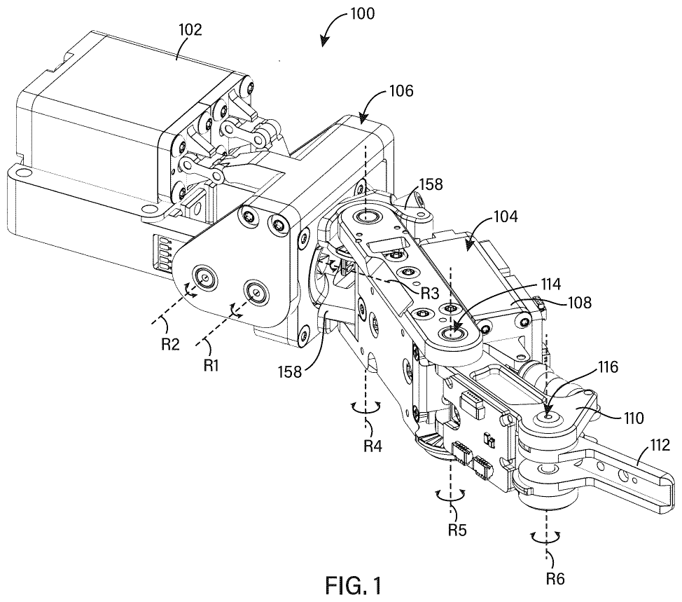

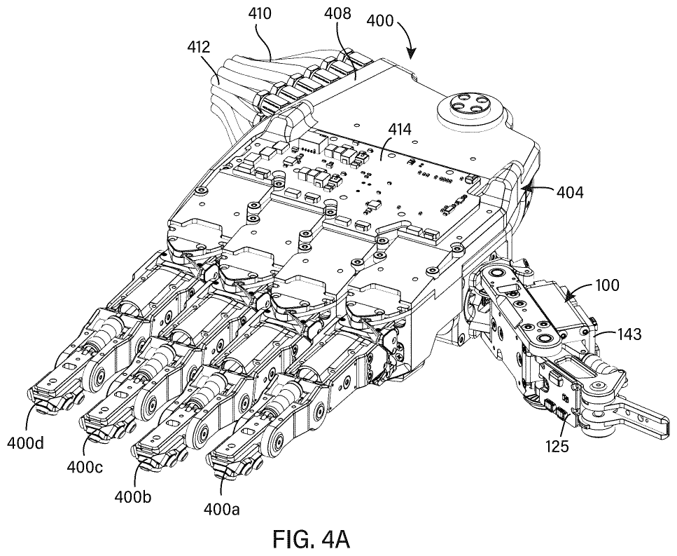

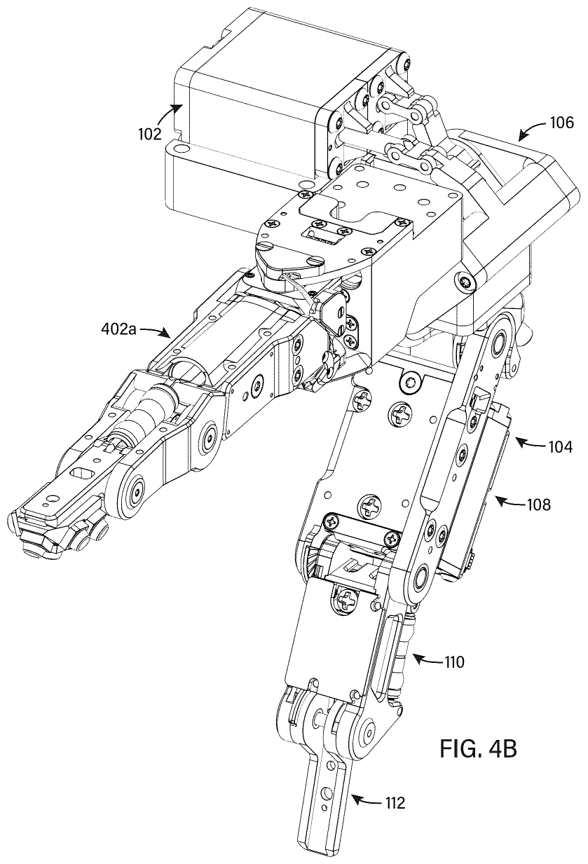

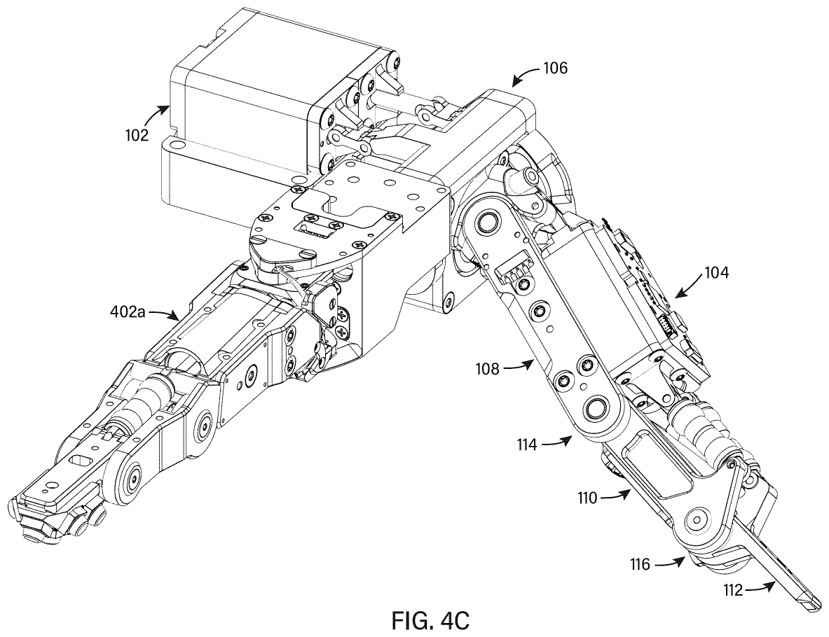

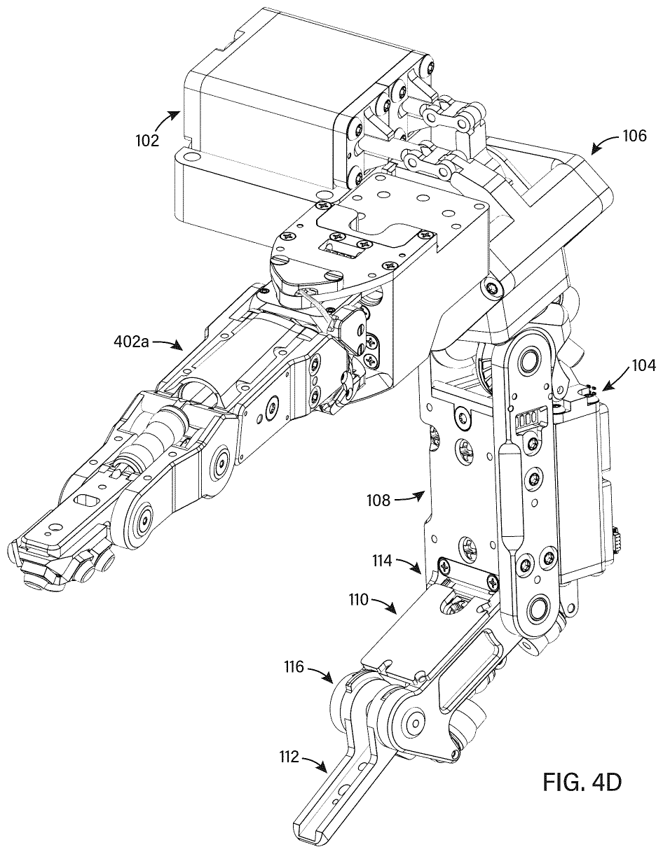

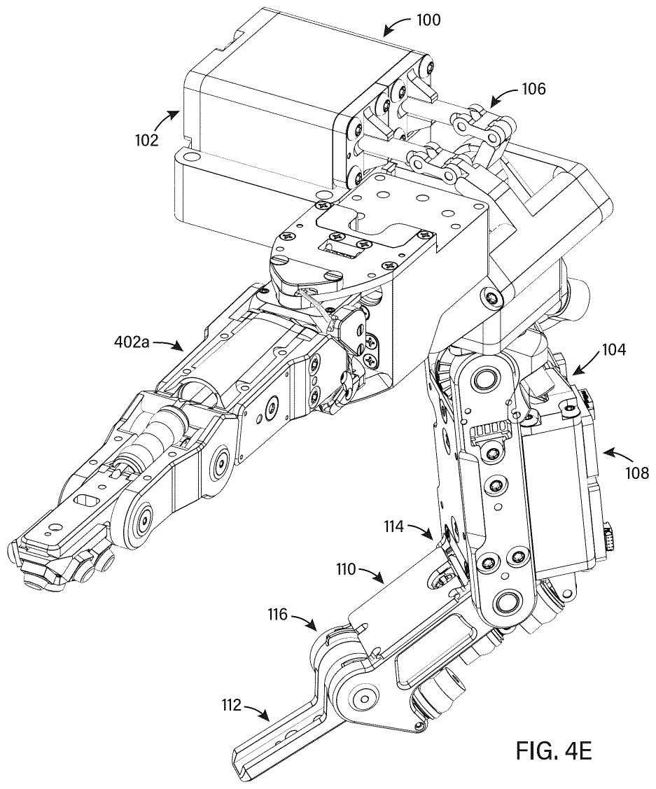

FIG. 1 illustrates an example robotic digit 100, which can be one of a plurality of robotic digits of a robotic hand (e.g., the robotic hand 400 in Example IV and FIG. 4A). In some examples, the robotic digit 100 is analogous to a human thumb and is described herein in terms that can be used to describe the anatomy of a humanoid thumb.

In one or more examples, the robotic digit 100 includes a digit base 102 that can be coupled to a palm of a robotic hand (as shown, for example, in FIG. 4A). The robotic digit 100 includes a digit body 104 coupled to the digit base 102 by a carpometacarpal (CMC) joint 106. In some examples, the CMC joint 106 is a multiple degree-of-freedom (multi-DOF) joint. In some examples, the CMC joint 106 has an opposition DOF including movement about a first axis R1 and/or a second axis R2, an abduction-adduction DOF including movement about a third axis R3, which can be orthogonal to the first and second axes R1, R2, and a flexion-extension DOF including movement about a fourth axis R4, which can be orthogonal to the third axis R3.

The digit body 104 is an articulated body comprised of links and joints. In some examples, the digit body 104 includes a metacarpal 108, a proximal phalanx 110, and a distal phalanx 112 as links. The proximal phalanx 110 is coupled to the metacarpal 108 by a metacarpophalangeal (MCP) joint 114 and to the distal phalanx 112 by an interphalangeal (IP) joint 116. Each of the MCP joint 114 and IP joint 116 has at least one DOF. In some examples, the MCP joint 114 has a flexion-extension DOF including movement about a fifth axis R5, which can be parallel to the fourth axis R4. In some examples, the IP joint 116 has flexion-extension DOF including movement about a sixth axis R6, which can be parallel to the fifth axis R5.

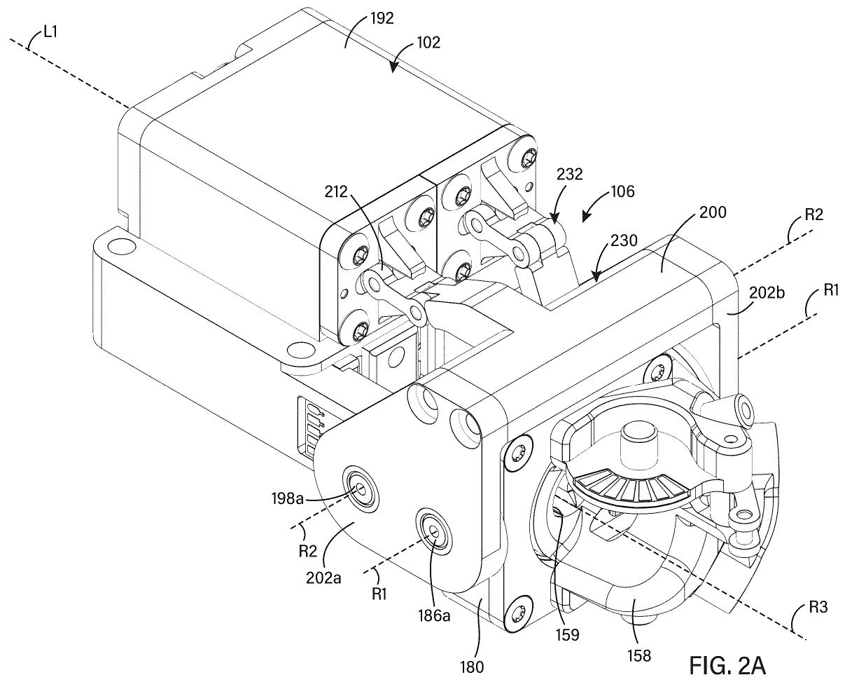

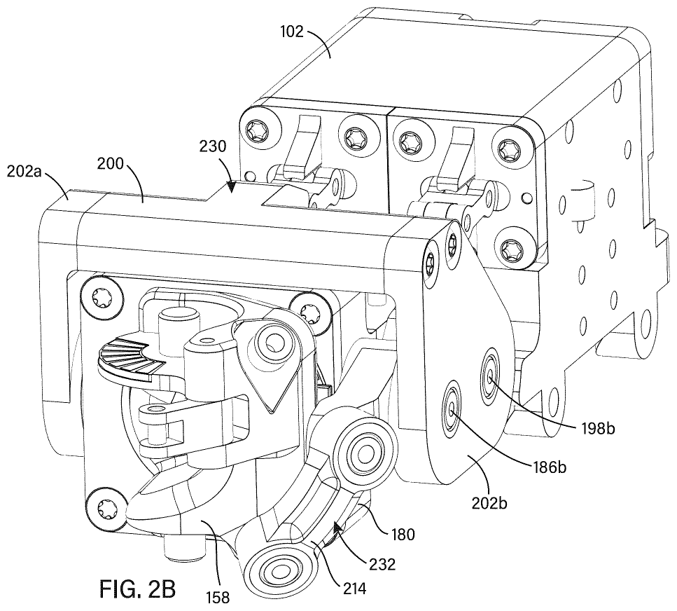

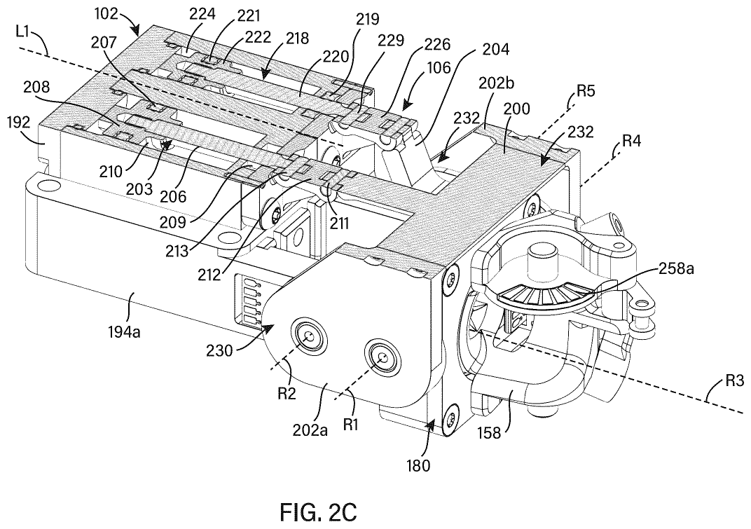

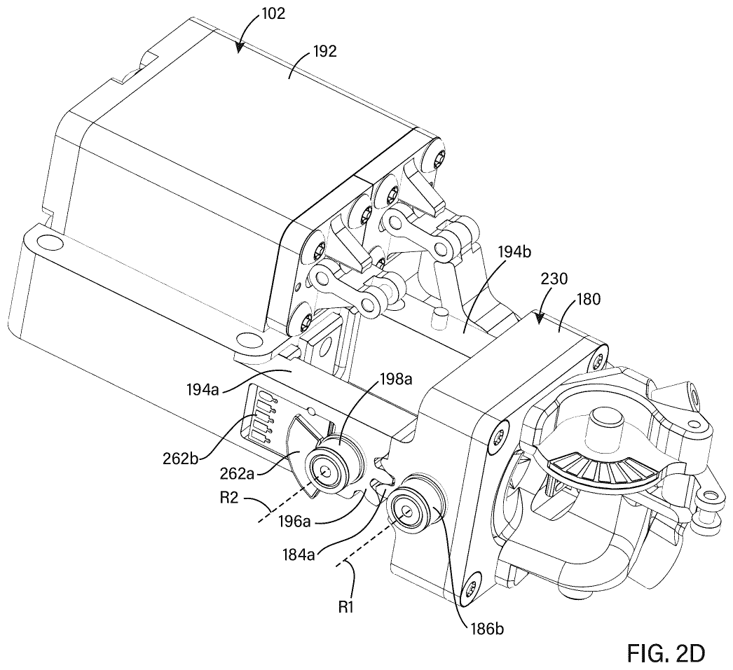

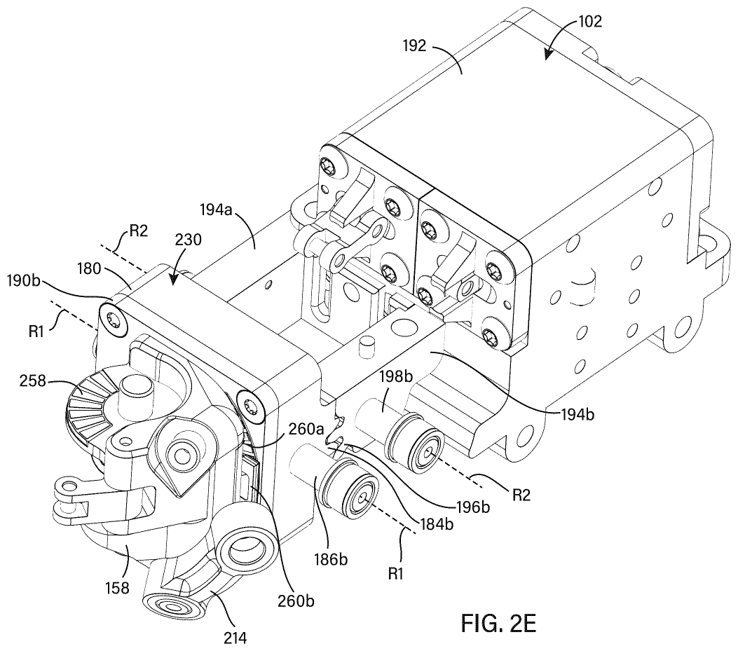

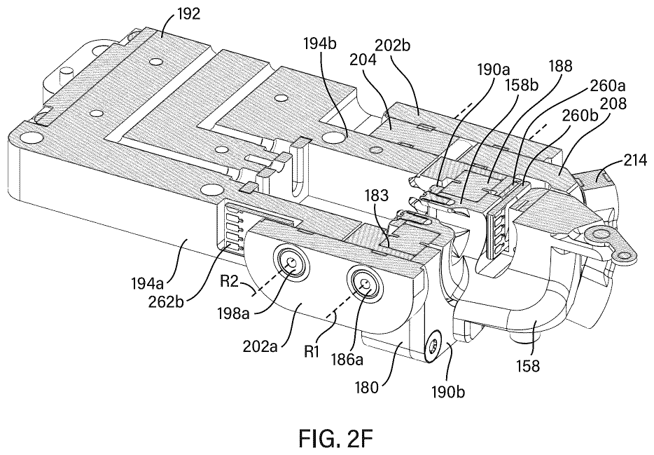

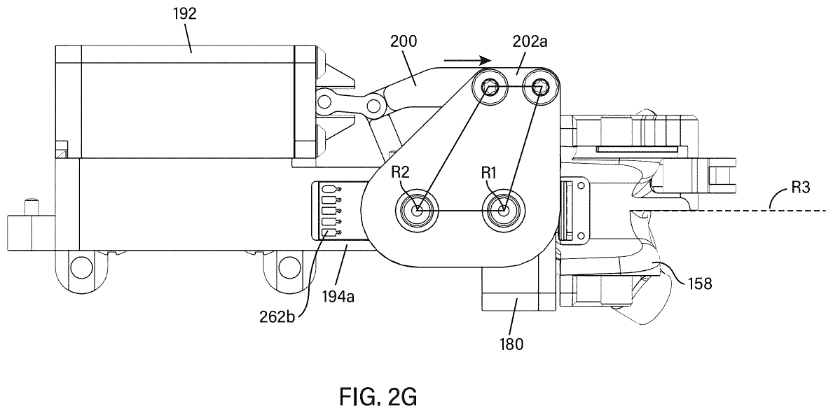

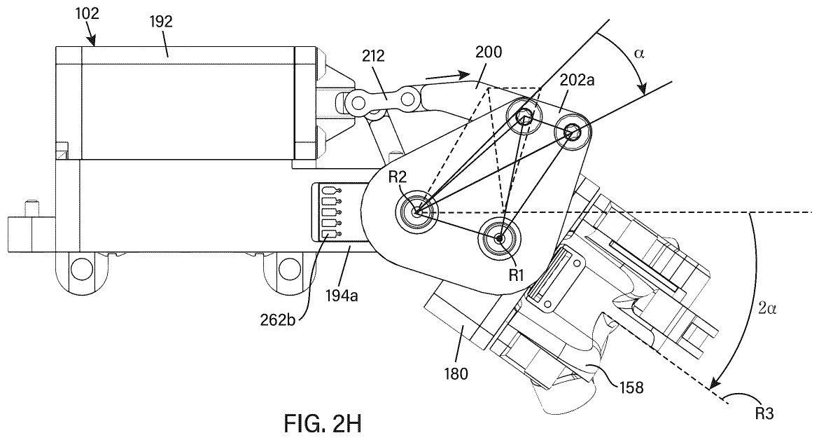

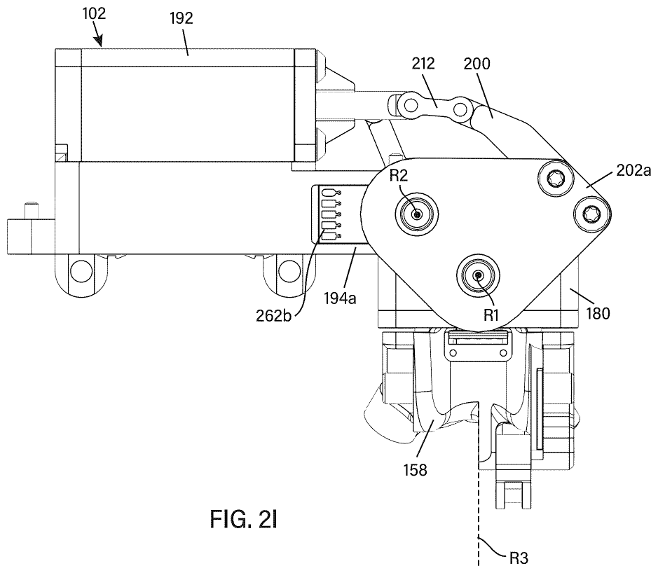

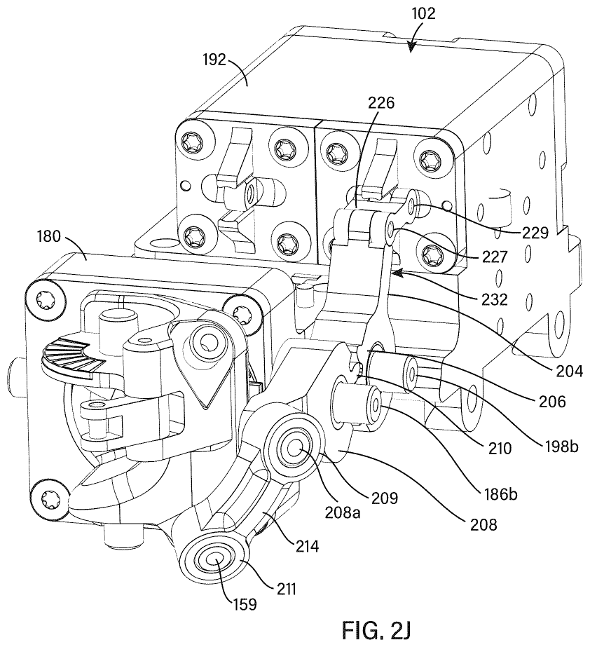

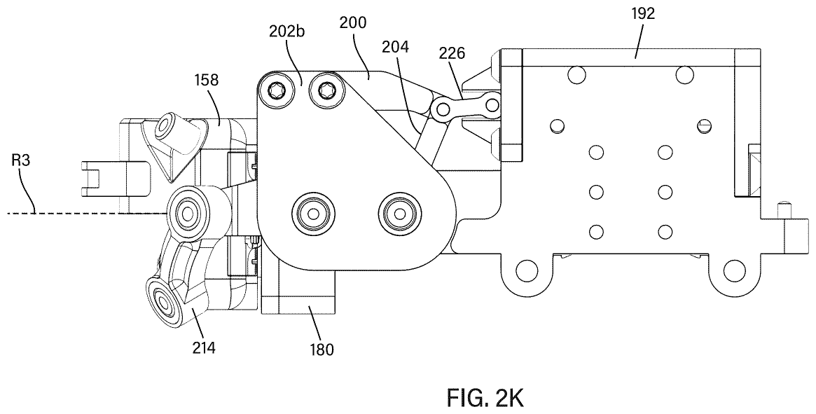

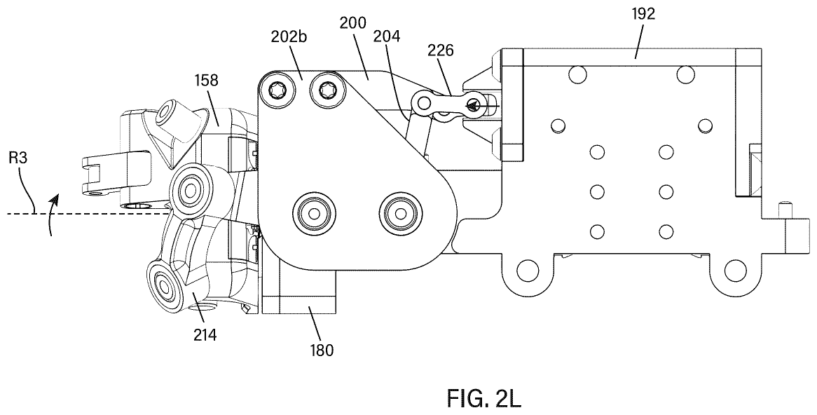

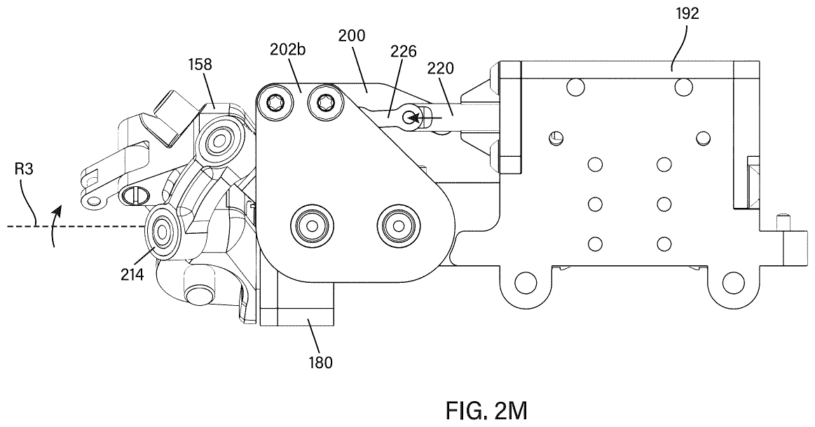

FIGS. 2A and 2B illustrate a subassembly including the CMC joint 106 and the digit base 102. FIGS. 2C-2G illustrate varying levels of details of the subassembly shown in FIGS. 2A and 2B.

Referring to FIGS. 2A-2C, the CMC joint 106 includes a CMC joint head 158, which can have a central opening 159 (e.g., for passage of line structures such as hydraulic lines, cables, and wires). The CMC joint head 158 can be pivotally coupled to the digit body 104 (as shown in FIG. 1). The CMC joint 106 includes a first CMC joint actuator 203 and a second CMC joint actuator 218 (shown in FIG. 2C), which can be supported by or coupled to a digit base frame 192 of the digit base 102. The CMC joint 106 can include a first mechanical linkage 230 arranged to transmit an output motion of the first CMC joint actuator 203 to the CMC joint head 158 and a second mechanical linkage 232 arranged to transmit an output motion of the second CMC joint actuator 218 to the CMC joint head 158 via independent paths.

The first CMC joint actuator 203 and the second CMC joint actuator 218 can be operated independently (synchronously or asynchronously). In some examples, the first CMC joint actuator 203 can be operated independently to provide the CMC joint head 158 with an opposition DOF. In some examples, the opposition DOF can include movements about a first axis R1 and a second axis R2 parallel to the first axis R1. The first axis R1 and the second axis R2 can be transverse (or orthogonal) to an axial axis L1 of the digit base frame 192. In some examples, the second CMC joint actuator 218 can be operated independently to provide the CMC joint head 158 with an abduction-adduction DOF. In some examples, the abduction-adduction DOF can include movements relative to a third axis R3 that is transverse (or orthogonal) to the first axis R1 and the second axis R2. The third axis R3 can be parallel to the axial axis L1 of the digit base frame 192.

In some examples, the first CMC joint actuator 203 can be a linear actuator (i.e., an actuator that creates linear motion). In one example, as shown in FIG. 2C, the first CMC joint actuator 203 can be a hydraulic cylinder including a first piston shaft 206 and a first piston 208 coupled to a proximal end of the first piston shaft 206. The first piston 208 is disposed within a first bore 210 formed in the digit base frame 192 and can move longitudinally within the first bore 210 in response to hydraulic pressure. The first piston 208 can carry a sealing element 207 that seals against a wall of the first bore 210. Although not shown in the drawing, the first piston shaft 206 can extend through a sealing element arranged at the exit of the first bore 210 (e.g., in the groove 209). In one example, the first CMC joint actuator 203 can be a double-acting hydraulic cylinder (e.g., hydraulic pressure can be selectively applied to both sides of the first piston 208), which can allow symmetric forward and backward opposition movement of the CMC joint head 158. The double-acting hydraulic cylinder may also avoid a separate mechanism to return the stroke of the first piston 208.

The first mechanical linkage 230 can include an oppose output 180 oppose output 180 oppose output 180 having an axial axis is aligned with the third axis R3 or parallel to the axial axis L1 of the digit base frame 192. As shown in FIGS. 2D-2E, the oppose output 180180 includes a proximal first gear portion 184a (shown in FIG. 2D) and a proximal second gear portion 184b (shown in FIG. 2E) disposed on opposite ends of the oppose output 180180 and parallel to each other. Posts 186a, 186b extend laterally outward from opposite sides of the oppose output 180180. The post 186a is on the same side of the oppose output 180180 as the proximal first gear portion 184a. The post 186b is on the same side of the oppose output 180180 as the proximal second gear portion 184b. The posts 186a, 186b are axially aligned along the first axis R1.

The CMC joint head 158 is rotatably coupled to the oppose output 180180. In one example, as shown in FIG. 2F, a proximal end portion 158b of the CMC joint head 158 extends into a central opening 183 of the oppose output 180180. A bearing 188 is disposed in the central opening 183, between the proximal end portion 158a of the CMC joint head 158 and an inner wall of the oppose output 180180, to support rotation of the CMC joint head 158 relative to the oppose output 180180. The bearing 188 is retained in the central opening 183 between a plate member 190a attached to the proximal end portion 158b of the CMC joint head 158 and a plate member 190b attached to the oppose output 180180. The plate members 190a, 190b extend radially over the bearing 188.

In some examples, as shown in FIGS. 2D-2F, the digit base 102 includes digit base frame extensions 194a, 194b extending distally from the digit base frame 192. The digit base frame extensions 194a, 194b can be integrally formed with (or otherwise attached to) the digit base frame 192. The digit base frame extensions 194a, 194b have gear portions 196a, 196b that are aligned and enmeshed with the gear portions 184a, 184b of the oppose output 180180 such that the gear portions 196a, 184a and 196b, 185b can cooperate to transmit motion. Posts 198a, 198b extend laterally outward from the sides of the digit base frame extensions 194a, 194b and are axially aligned along the second axis R2.

As shown in FIGS. 2A and 2B, the first mechanical linkage 230 can include an oppose link 200 and oppose plates 202a, 202b attached to opposite sides of the oppose link 200. The oppose plate 202a is pivotably coupled to the digit base frame extension 194a and the oppose output 180180. For example, the oppose plate 202a is mounted on the posts 186a, 198a by receiving the posts 186a, 198a in corresponding holes in the oppose plate 202a. Bushings can be fitted into the holes in the oppose plate 202a to support pivoting of the oppose plate 202a on the posts 186a, 198a. The oppose plate 202b is pivotably coupled to the digit base frame extension 194b and the oppose output 180. For example, the oppose plate 202b is mounted on the posts 186b, 198b by receiving the posts 186, 198b into corresponding holes in the oppose plate 202b. Bushings can be fitted in the holes in the oppose plate 202b to support pivoting of the oppose plate 202b on the posts 186b, 198b. The oppose plates 202a, 202b can pivot about the first axis R1 due to the pivot joints formed at the posts 186a, 186b and can pivot about the second axis R2 due to the pivot joints formed at the posts 198a, 198b.

As shown in FIG. 2C, a proximal end portion of the oppose link 200 can be coupled to the first CMC joint actuator 203 via a first link 212. For example, the proximal end of the oppose link 200 can have a hole that is disposed between and aligned with a pair of spaced holes at the distal end of the first link 212. A pin 211 can be inserted through the aligned holes to pivotally couple the proximal end portion of the oppose link 200 to the first link 212. Similarly, the distal end of the first piston shaft 206 can have a hole that is disposed between and aligned with a pair of spaced holes at the proximal end of the first link 212. A pin 213 can be inserted through the aligned holes to pivotally couple the distal end of the first piston shaft 206 to the first link 212.

Movement of the first piston 208 within the bore 210 in response to differential pressure across the first piston 208 causes displacement of the oppose link 200 and pivoting of the oppose plates 202a, 202b about the first axis R1 and the second axis R2. Motion of the oppose plates 202a, 202b is transmitted to the oppose output 180180 through the enmeshed gear portions 184a, 196a and 184b, 196b (shown in FIGS. 2D-2E). FIG. 2G shows the oppose link 200 at a neutral position, according to one example. FIGS. 2H and 2I show the oppose link 200 displaced from the neutral position, causing rotation of the oppose output 180180. Displacement of the oppose link 200 causes double rotation of the oppose plates at the axes R1 and R2. FIG. 2H illustrates that when the coupler rotates by an angle α at each of the axes R1 and R2, the oppose output 180180 rotates by an angle 2α.

In some examples, the second CMC joint actuator 218 can be a linear actuator. In one example, as shown in FIG. 2C, the second CMC joint actuator 218 can be a hydraulic cylinder including a second piston shaft 220 and a second piston 222 attached to a proximal end of the second piston shaft 220. The second piston 222 is disposed within a second bore 224 formed in the base body 192 and can move longitudinally within the second bore 224 in response to differential pressure across the second piston 222. The second piston 222 can carry a sealing element 221 that seals against a wall of the second bore 224 and isolate a proximal portion of the second bore 224 from a distal portion of the second bore 224. The second piston shaft 220 can extend through a sealing element 219 arranged at the exit of the second bore 224. The sealing element 219 can prevent leakage of fluid from the distal portion of the second bore 224. In one example, the second piston 222 can be a double-acting hydraulic cylinder (e.g., hydraulic pressure can be selectively applied to both sides of the second piston 222 to create differential pressure across the second piston 222), which can allow symmetric abduction and adduction of the CMC joint head 158. The double-acting hydraulic cylinder may also avoid a separate mechanism to return the stroke of the second piston 222.

In some examples, as shown in FIG. 2J, the second mechanical linkage 232 can include an abduct input arm 204 having a gear portion 206 pivotally mounted on the post 198b extending laterally from the base arm 198b. The second mechanical linkage 232 can include an abduct output arm 208 having a gear portion 210 pivotally mounted on the post 186b extending laterally from the oppose output 180180. The gear portion 210 is enmeshed with the gear portion 206 such that the gear portions 210, 206 can cooperate to transmit motion. The abduct output arm 208 is coupled to the CMC joint head 158 by a spherical linkage 214. For example, an end portion of the abduct output arm 208 can include a post 208a that extends into a hole in an end portion of the spherical linkage 214. A bushing 209 can be fitted in the hole to support pivoting of the spherical linkage 214 on the post 208a. The CMC joint head 158 can include a post 159 that extends into a hole at another end portion of the spherical linkage 214. A bushing 211 can be fitted in the hole to support pivoting of the spherical linkage 214 on the post 159.

Referring to FIGS. 2C and 2J, the abduct input arm 204 is coupled to the second CMC joint actuator 218 (shown in FIG. 2C) so that an output motion of the second CMC joint actuator 218 can be transmitted through the enmeshed gear portions 206, 210 to the spherical linkage 214. A proximal end portion of the abduct input arm 204 can have a hole that is aligned with a pair of spaced holes at a distal end of a second link 226. A pin 227 can be inserted through the aligned holes to pivotally couple the proximal end portion of the abduct input arm 204 to the second link 226. Similarly, the distal end of the second piston shaft 220 (shown in FIG. 2C) can have a hole that is aligned with a pair of spaced holes at the proximal end of the second link 226. A pin 229 (shown in FIG. 2C) can be inserted through the aligned holes to pivotally couple the distal end of the second piston shaft 220 to the second link 226.

The output motion of the second CMC joint actuator 218 (e.g., the longitudinal movement of the second piston 222 within the second bore 224) causes relative movement between the enmeshed gear portions 206, 210, which causes movement of the spherical linkage 214, resulting in abduction (or adduction) movement of the CMC joint head 158. FIG. 2K illustrates the second mechanical linkage 232 in a neutral position, according to some examples. FIGS. 2L and 2M illustrate movement of the mechanical linkage 232 by action of the second CMC joint actuator 218. The movement of the mechanical linkage 232 results in rotation of the CMC joint head 158. In some examples, the CMC joint head 158 rotates about a point on the third axis R3 (or moves on a virtual spherical surface having a center on the third axis R3) due to the presence of the spherical linkage 214.

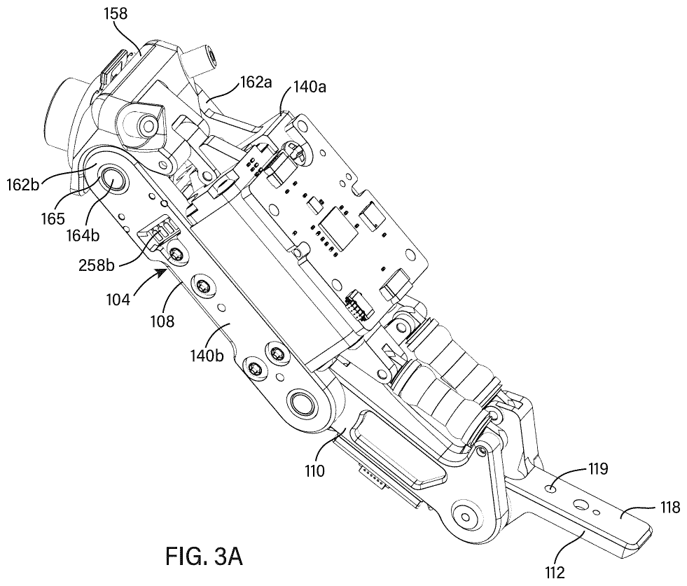

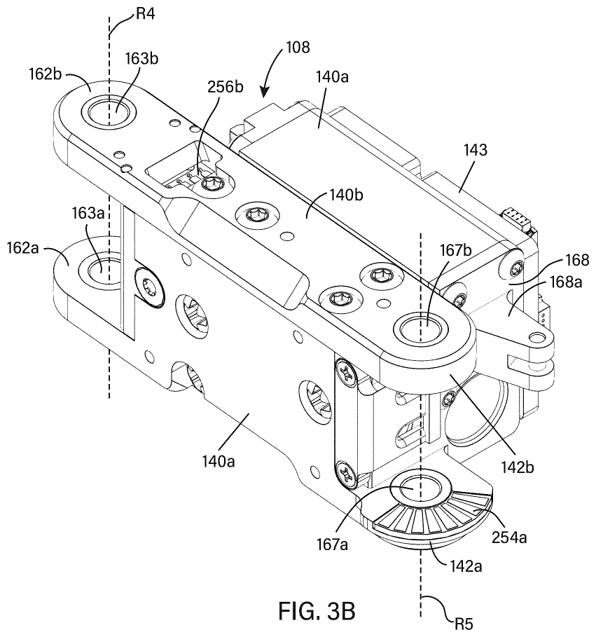

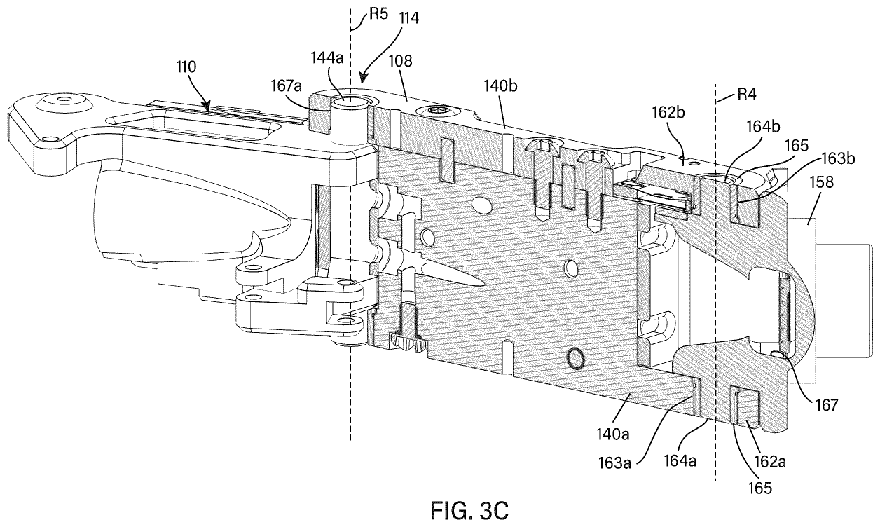

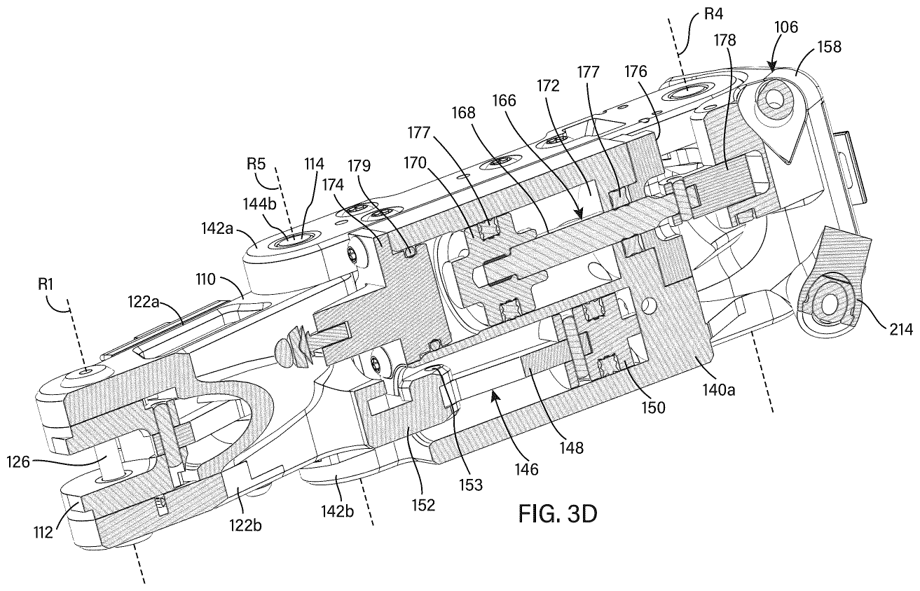

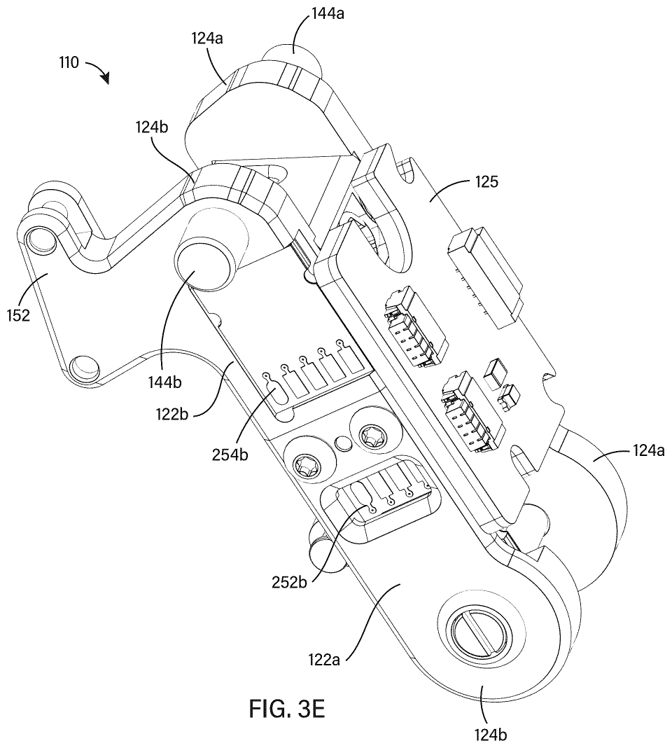

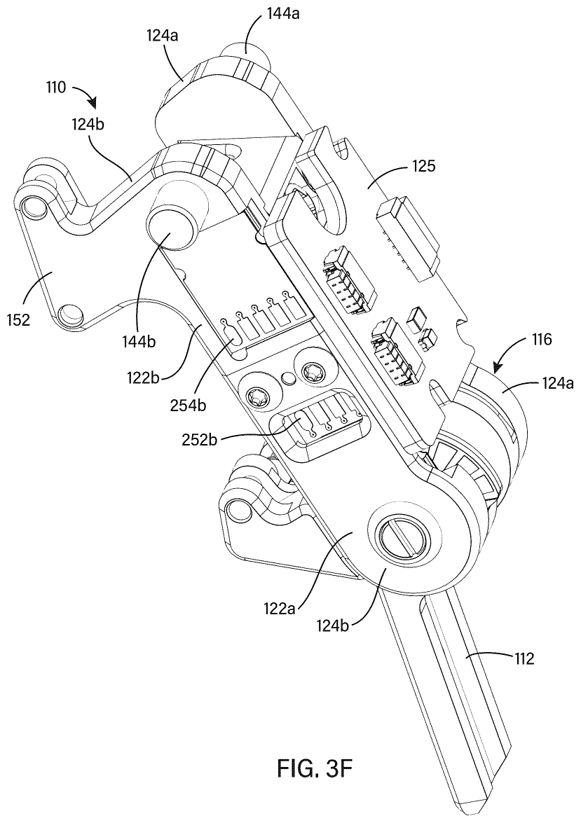

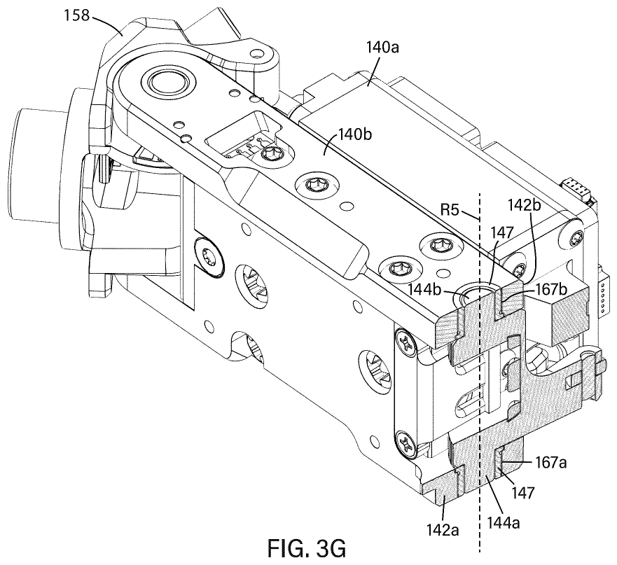

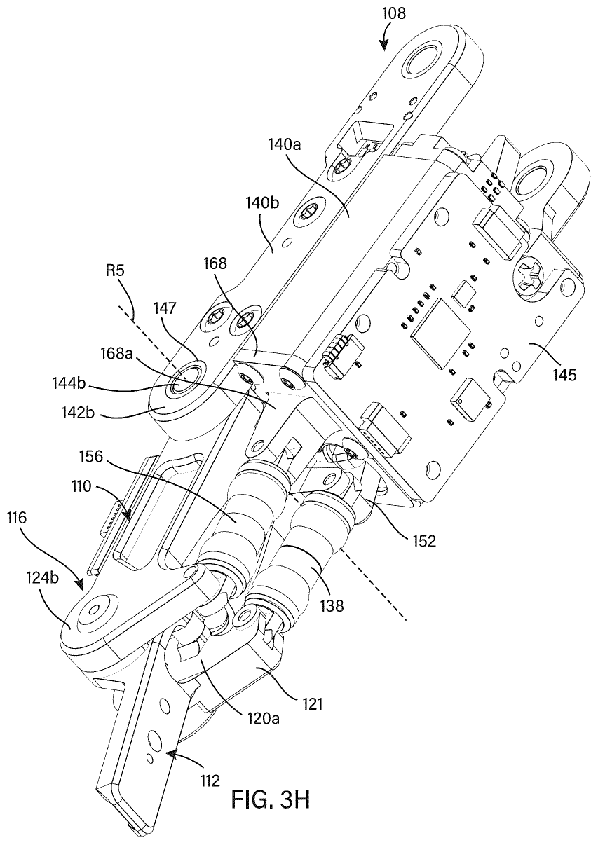

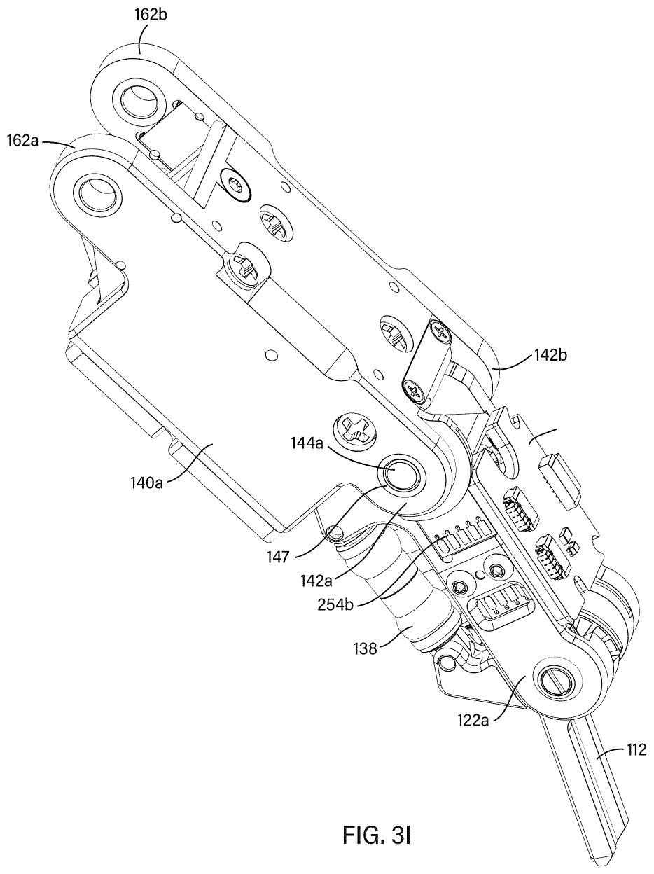

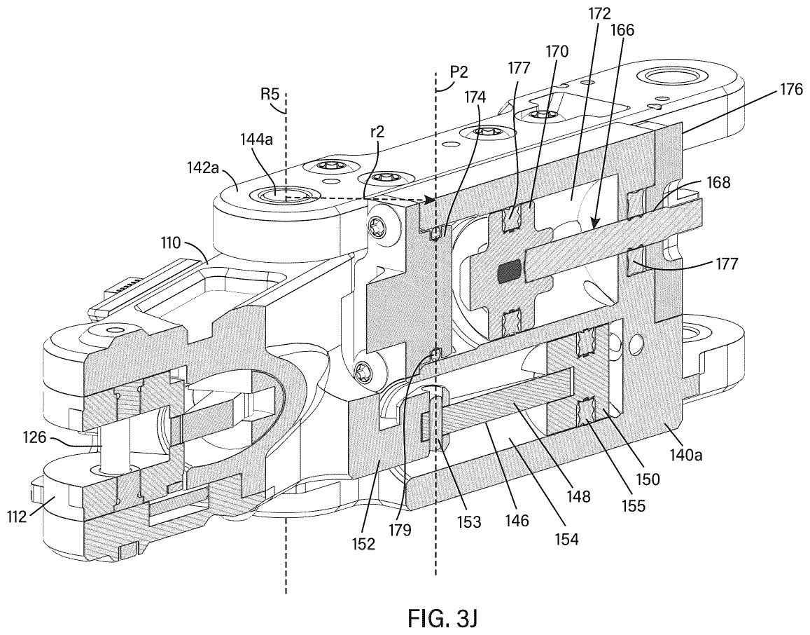

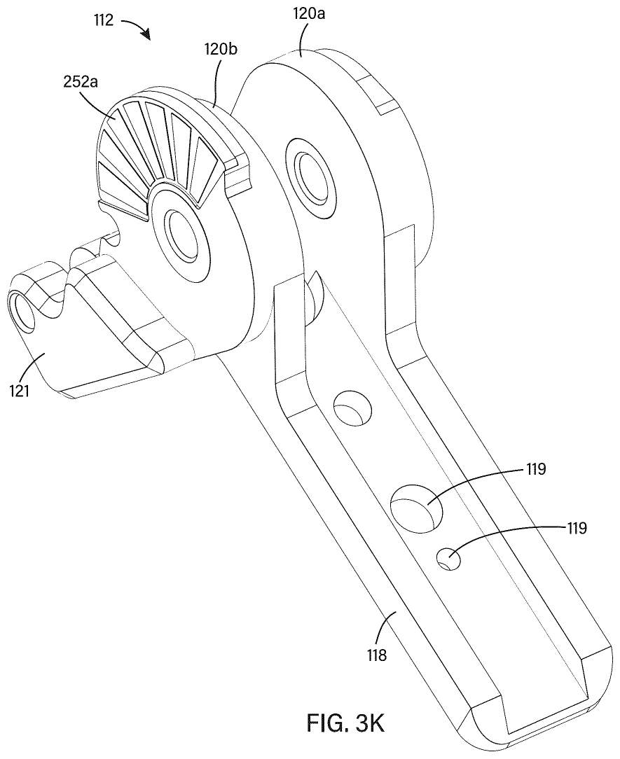

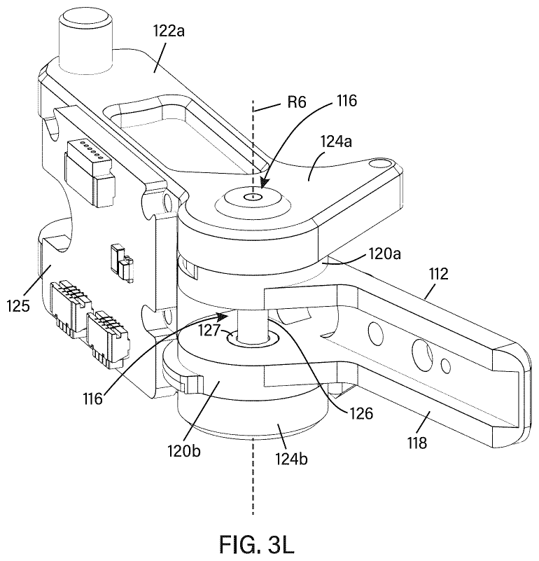

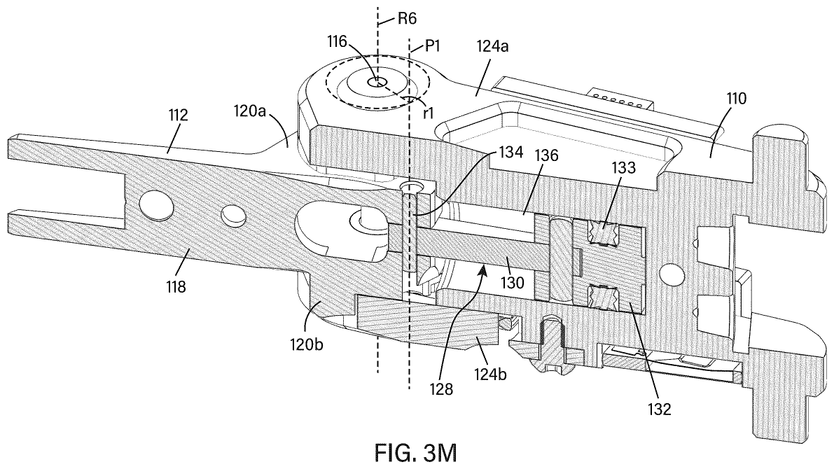

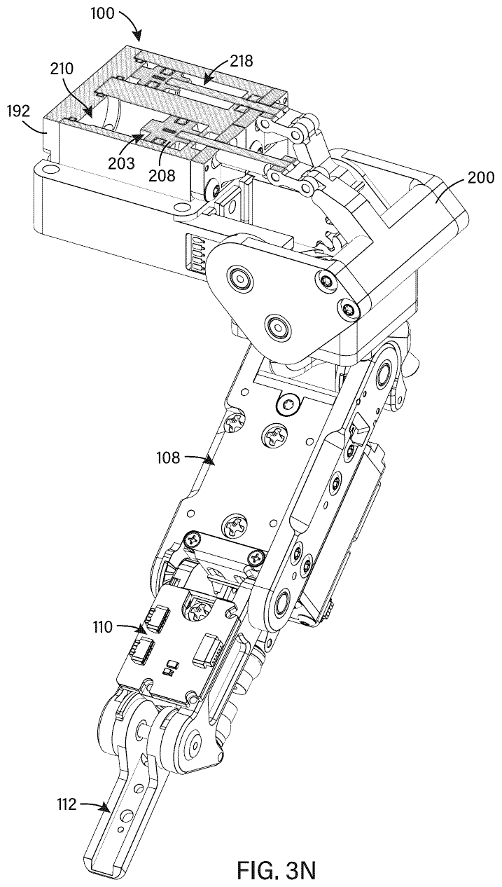

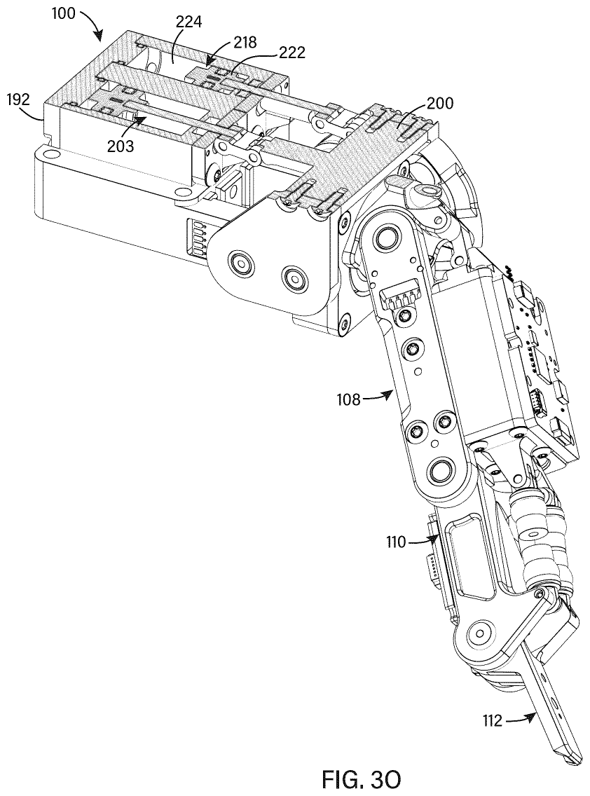

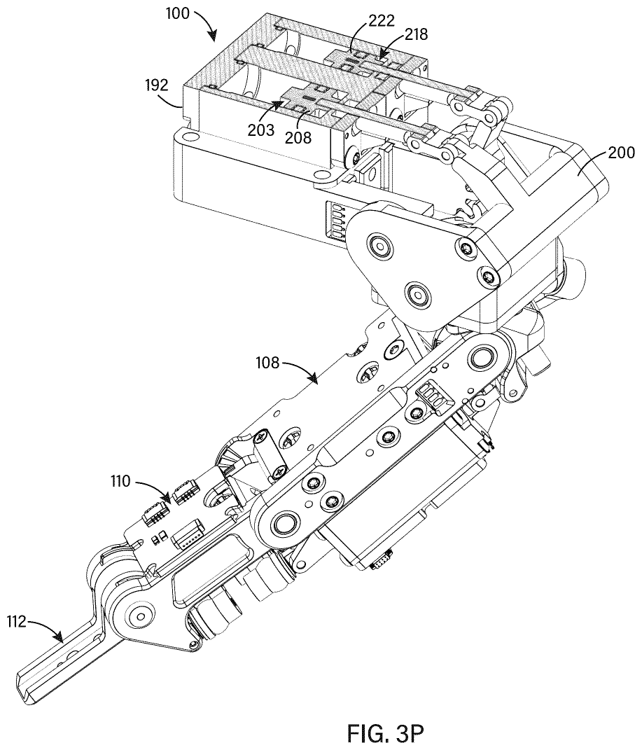

FIG. 3A illustrates a robotic digit subassembly including the digit body 104 and the CMC joint head 158. FIGS. 3B-3P illustrate varying details of the subassembly shown in FIG. 3A.

In some examples, as shown in FIG. 3B, the metacarpal 108 of the digit body 104 can include a metacarpal frame 140a and a metacarpal frame extension 140b removably attached to the metacarpal frame 140a. The metacarpal frame 140a includes a proximal first flange portion 162a having a hole 163a and a distal first flange portion 142a having a hole 167a. The metacarpal frame extension 140b includes a proximal second flange portion 162b having a hole 163b and a distal second flange portion 142b having a hole 167b. The proximal flange portions 162a, 162b are disposed on opposite sides of the metacarpal 108 and are parallel to each other, with the holes 163a, 163b axially aligned. The distal flange portions 142a, 142b are disposed on opposite sides of the metacarpal 108 and are parallel to each other, with the holes 167a, 167b axially aligned.

As shown in FIGS. 3A and 3C, the CMC joint head 158 is pivotally coupled to the metacarpal 108. For example, the CMC joint head 158 can be positioned between the proximal flange portions 162a, 162b such that laterally extending posts 164a, 164b on opposite sides of the CMC joint 158 extend into the corresponding holes 163a, 163b in the proximal flange portions 162a, 162b. Each of the holes 163a, 163b can include a bushing 165 to support pivoting of the metacarpal 108 on the posts 164a, 164b. The holes 163a, 163b and the posts 164a, 164b are axially aligned along the fourth axis R4, and the metacarpal 108 is pivotable relative to the CMC joint head 158 about the fourth axis R4.

In some examples, as illustrated in FIG. 3D, a third CMC joint actuator 166 can be arranged to actuate the pivot joint formed between the CMC joint head 158 and the metacarpal 108. In some examples, the third CMC joint actuator 166 can be a linear actuator. In one example, the third CMC joint actuator 166 can be a hydraulic cylinder including a third piston shaft 168 and a third piston 170 coupled to a distal end of the third piston shaft 168. The third piston 170 can be disposed in a bore 172 formed in the metacarpal frame 140a and movable therein. The bore 172 can be capped at a distal end by a back plate 174 attached to the distal end of the metacarpal frame 140a and at a proximal end by a front plate 176 attached to a proximal end of the metacarpal body 140a. The third piston 170, back plate 174, and front plate 176 can carry sealing elements 177, 179 that seal against the wall of the bore 172 and allow the portion of the bore 172 on the distal side of the third piston 170 to be isolated from the portion of the bore 172 on the proximal side of the third piston 170. The metacarpal frame 140a can have ports through which hydraulic fluid can be fed into the portions of the bore 172 on either side of the third piston 170. A proximal end portion of the third piston shaft 168 extends proximally through an opening in the front plate 176 and is pivotally coupled to the CMC joint head 158, for example, via a flexion link 178.

Movement of the third piston 170 in response to differential pressure across the third piston 170 causes movement of the third piston shaft 168 and displacement of the flexion link 178, which results in relative rotation between the metacarpal 108 and the CMC joint head 158 about the fourth axis R4, corresponding to a flexion DOF of the CMC joint 106. In one example, the third CMC joint actuator 166 is a double-acting hydraulic cylinder (e.g., hydraulic pressure can be selectively applied to both sides of the third piston 170 to produce a differential pressure across the third piston 170). In another example, the third CMC joint actuator 166 can be a single-acting hydraulic cylinder (e.g., hydraulic pressure is applied to only one side of the third piston 170 to produce a differential pressure across the third piston 170). In the case of the single-acting hydraulic cylinder, a mechanism (such as a spring) may be arranged to return the stroke of the piston.

The MCP joint 114 is formed between the proximal phalanx 110 and the metacarpal 108. In one or more examples, as shown in FIGS. 3E-3F, the proximal phalanx 110 can include a proximal phalanx frame 122a and a proximal phalanx frame extension 122b removably attached to a side of the proximal phalanx frame 122a. The proximal phalanx frame 122a has a first flange portion 124a. The proximal phalanx frame extension 122b has a second flange portion 124b. The proximal phalanx frame extension 122b can be mounted on a side of the proximal phalanx frame 122a such that the second flange portion 124b and the first flange portion 124a are parallel and spaced apart.

In some examples, as shown in FIGS. 3C-3D and 3G, the metacarpal 108 is pivotally coupled to the proximal phalanx 110 by receiving posts 144a, 144b extending laterally from opposite sides of the proximal phalanx 110 in the holes 167a, 167b in the distal flanges 142a, 142b of the metacarpal frame 140a and metacarpal frame extension 140b. Bushings 147 can be fitted in the holes 167a, 167b to support rotation of the posts 144a, 144b within the holes. The posts 144a, 144b are axially aligned along the fifth axis R5, allowing relative rotation between the proximal phalanx 110 and the metacarpal 108 about the fifth axis R5.

As shown in FIG. 3J, an MCP joint actuator 146 can be arranged to actuate the MCP joint 114. In some examples, the MCP joint actuator 146 can be a linear actuator. In one example, the MCP joint actuator 146 can be a hydraulic cylinder including a fourth piston shaft 148 and a fourth piston 150 coupled to a proximal end of the fourth piston shaft 148. A distal end of the fourth piston shaft 148 can be pivotally coupled to a proximal flange portion 152 of the proximal phalanx 110 such that the fourth piston shaft 148 forms a link between the fourth piston 150 and the proximal phalanx 110. For example, the distal end portion of the fourth piston shaft 148 can have a hole that is transverse to an axial axis of the fourth piston shaft 148 and axially aligned with holes in the proximal flange portion 152. A pin 153 can be inserted through the aligned holes and can be retained relative to the proximal flange portion 152. The pin 153 can have an axial axis P2 that is parallel to the fifth axis R5 and offset from the fifth axis R5 by a radius r2. The radius r2 forms a moment arm for a force applied at the pin 153 by the MCP joint actuator 146

In some examples, the fourth piston 150 is disposed within a bore 154 formed in the metacarpal body 140a. The fourth piston shaft 148 can extend through an opening at a distal end of the metacarpal body 140a to form a link between the fourth piston shaft 148 and the proximal phalanx 110. The fourth piston 150 can move longitudinally within the bore 154 in response to hydraulic pressure provided in the bore 154. The metacarpal frame 140a can have ports through which hydraulic fluid can be fed to the bore 154. The fourth piston 150 can carry a sealing element 155 that seals between the external surface of the fourth piston 150 and the inner wall of the bore 154.

Movement of the fourth piston 150 within the bore 154 causes displacement of the fourth piston shaft 148 and rotation of the proximal phalanx 110 relative to the metacarpal 108 about the fifth axis R5. The torque applied to the proximal phalanx 110 is a function of the force applied by MCP joint actuator 146 at the pin 153 and the moment arm r2. Rotation of the proximal phalanx 110 relative to the metacarpal 108 about the fifth axis R5 corresponds to a flexion-extension DOF.

The MCP joint actuator 146 can be a single-acting hydraulic cylinder or a double-acting hydraulic cylinder. For a single-acting hydraulic cylinder, a spring mechanism can be arranged to return the stroke of the piston. In one example, as shown in FIG. 3H, a first bias member 156 (e.g., a spring as described in Example IV) can be arranged to return the stroke of the fourth piston 150 (shown in FIG. 3I). In one example, a back plate 168 can be attached to a distal end of the metacarpal frame 140a. The first bias member 156 can have one end coupled to an anchor portion 168a of the back plate 168 and another end coupled to the first flange portion 124a of the proximal phalanx 110 such that the first bias member 156 extends longitudinally between the proximal phalanx 110 and the metacarpal 108. The first bias member 156 can be configured to bias the proximal phalanx 110 to a neutral position. When the hydraulic pressure on one side (e.g., the proximal side) of the fourth piston 150 overcomes the biasing force of the first bias member 156, the fourth piston 150 moves in a direction (e.g., a distal direction) to cause rotation of the proximal phalanx 110 relative to the metacarpal 108 about the fifth axis R5. The first bias member 156 can return the proximal phalanx 110 to the neutral position when the hydraulic pressure is released.

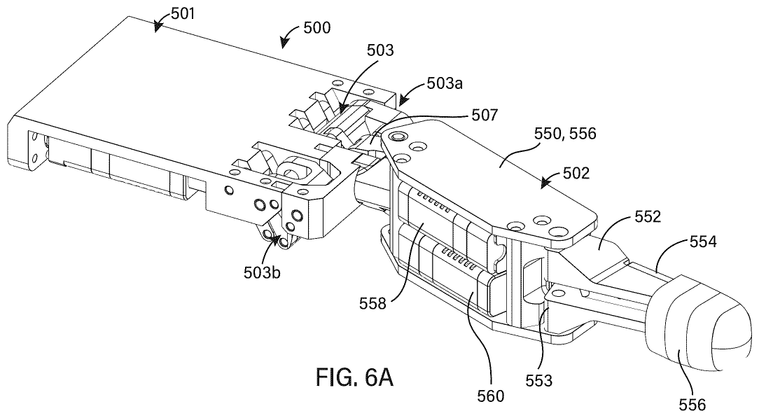

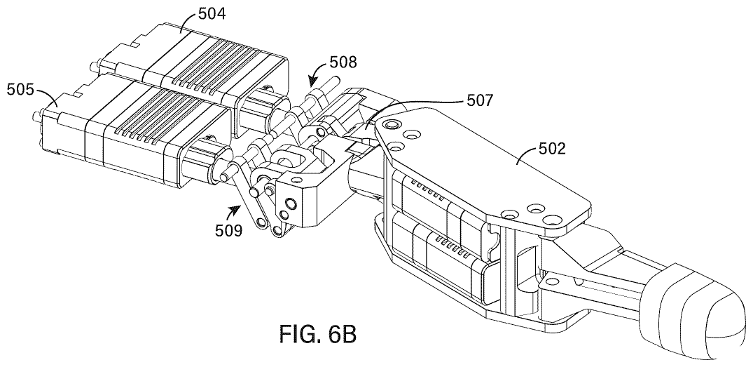

The IP joint 116 is formed between the proximal phalanx 110 and the distal phalanx 112. In one or more examples, as shown in FIG. 3K, the distal phalanx 112 can be in the form of a pivotable lever. The distal phalanx 112 can include a tab portion 118, which can form a tip of the robotic digit 100 (shown in FIG. 1). The tab portion 118 can include mounting features (e.g., holes 119 that can receive fasteners) for touch-related components (e.g., contact pads or touch sensors). A tactile sensor can be mounted on the tab portion 118 (see, e.g., tactile sensor 556 in FIGS. 9 and 6A and Example V). The distal phalanx 112 can include a first flange portion 120a and a second flange portion 120b arranged in parallel and spaced from each other. A proximal end portion of the tab portion 118 can be fixedly attached to (or integrally formed with) the flange portions 120a, 120b such that the tab portion 118 projects outwardly relative to the flange portions 120a, 120b.

In some examples, as shown in FIG. 3L, the proximal phalanx 110 is pivotally coupled to the distal phalanx 112 by positioning the first flange portion 124a of the proximal phalanx 110 adjacent to the first flange portion 120a of the second phalanx 112 and positioning the second flange portion 124a of the proximal phalanx 110 adjacent to the second flange portion 120b of the second phalanx 112. A pivot member 126 (e.g., a shoulder bolt) can be extended through aligned holes in the flange portions 124a, 124b, 120a, 120b and fixed relative to the proximal phalanx 110 (e.g., by a threaded connection formed between the pivot member 126 and at least one of the receiving holes in the flange portions 124a, 124b). The distal phalanx 112 is movable on the pivot member 126. In some examples, the pivot member 126 can extend through bushings 127 fitted into the holes in the flange portions 120a, 120b. The pivot member 126 is axially aligned with the sixth axis R6 such that the distal phalanx 112 can rotate relative to the proximal phalanx 110 about the sixth axis R6.

In some examples, as shown in FIG. 3M, an IP joint actuator 128 can be arranged to actuate the IP joint 116. In some examples, the IP joint actuator 128 can be a linear actuator. In one example, the IP joint actuator 128 can be a hydraulic cylinder including a fifth piston shaft 130 and a fifth piston 132 coupled to a proximal end of the fifth piston shaft 130. In one or more examples, a distal end of the fifth piston shaft 130 can be coupled to the distal phalanx 112 (e.g., to the flange portions 120a, 120b of the distal phalanx 112) such that the fifth piston shaft 130 forms a link between the fifth piston 132 and the distal phalanx 112. For example, the distal end portion of the fifth piston shaft 130 can have a hole that is transverse to an axial axis of the fifth piston shaft 130 and axially aligned with holes in the first and second flange portions 120a, 120b. A pin 134 can be extended through the aligned holes and can be retained relative to the first and second flange portions 120a, 120b. The pin 134 can have an axial axis P1 that is parallel to the sixth axis R6 and offset from the sixth axis R6 by a radius r1. The radius r1 forms a moment arm for a force applied at the pin 134 by the IP joint actuator 128.

In some examples, the fifth piston 132 is disposed within a bore 136 formed in the proximal phalanx body 122a. The fifth piston 132 can move longitudinally within the bore 136 in response to hydraulic pressure provided in the bore 136. The proximal phalanx body 122a can have one or more ports through which hydraulic fluid can be fed to the bore 136. The fifth piston 132 can carry a sealing element 133 that seals between the external surface of the fifth piston 132 and the inner wall of the bore 136 as is known in the art. Movement of the fifth piston 132 within the bore 136 causes displacement of the fifth piston shaft 130 and rotation of the distal phalanx 112 about the sixth axis R6. The torque applied to the distal phalanx 112 is a function of the force applied by the IP joint actuator 128 at the pin 134 and the moment arm r1. Rotation of the distal phalanx 112 relative to the proximal phalanx 110 about the sixth axis R6 can provide one of the flexion DOFs of the robotic digit 100 (shown in FIG. 1).

The IP joint actuator 128 can be a single-acting hydraulic cylinder (e.g., hydraulic pressure is applied on only one side of the piston) or a double-acting hydraulic cylinder (e.g., hydraulic pressure can be applied on both sides of the piston). For a single-acting hydraulic cylinder, a bias member can be arranged to return the stroke of the piston. In one example, as shown in FIGS. 3H and 3I, a second bias member 138 (e.g., a spring as described in Example IV) can have one end coupled to the distal phalanx 112 (e.g., to a flange extension 121 of the first flange portion 120a) and another end coupled to the proximal phalanx 110 (e.g., to a proximal flange portion 152 of the proximal phalanx 110) such that the second bias member 138 extends longitudinally between the distal phalanx 112 and the proximal phalanx 110. The second bias member 138 can be designed to bias the distal phalanx 112 to a neutral position (which can be defined by a selected angle between an axial axis of the proximal phalanx 110 and an axial axis of the distal phalanx 112). When the hydraulic pressure provided on one side (e.g., the proximal side) of the fifth piston 132 (in FIG. 3M) overcomes the biasing force of the second bias member 138, the fifth piston 132 moves in a direction (e.g., a distal direction) to cause rotation of the distal phalanx 112 relative to the proximal phalanx 110 about the sixth axis R6. The second bias member 138 can return the distal phalanx 112 to the neutral position when the hydraulic pressure is released.

FIGS. 3N-3P illustrate example spatial poses of the robotic digit 100 after actuation of one or more DOFs. FIG. 3N shows a spatial pose of the robotic digit 100 after the first CMC joint actuator 203 has been operated to effect an opposition movement of the robotic digit 100 from the neutral position shown in FIG. 1. As can be observed, the first piston 208 has moved to the distal end of the first bore 210, corresponding to a maximum opposition of the robotic digit 100 according to some examples. FIG. 3O shows a spatial pose of the robotic digit 100 after the second CMC joint actuator 218 has been operated to effect an abduction of the robotic digit 100 from the neutral position shown in FIG. 1. As can be observed, the second piston 222 has moved to the distal end of the second bore 224, corresponding to a maximum abduction movement according to some examples. FIG. 3P shows a spatial pose of the robotic digit 100 when first piston 208 and the second piston 222 are both at the distal ends of their strokes, corresponding to a combination of maximum opposition and maximum abduction according to some examples. The spatial pose of the robotic digit 100 can be additionally adjusted by actuating any of the other DOFs (e.g., the joint formed between the metacarpal 108 and the CMC joint head 158, the joint formed between the metacarpal 108 and the proximal phalanx 110, and the joint formed between the proximal phalanx 110 and the distal phalanx 112).

In the illustrated examples, the actuators 203, 218, 166, 146, 128 are shown as hydraulic cylinders, which can be single-acting or double-acting. In other examples, the actuators can be other types of actuators (e.g., pneumatic actuators or electric actuators).

In the illustrated examples, the first and second mechanical linkages 230, 232 use rigid links. In other examples, the mechanical linkages 230, 232 can be replaced by mechanical tendons (e.g., cables). For example, mechanical tendons can be coupled to the CMC joint head 158, and the actuators 203, 218 can be configured to selectively apply tension to the mechanical tendons and release tension from the mechanical tendons in order to place the CMC joint head 158 in a desired orientation in a 3D space.

### Example III—Sensor System for the Robotic Digit

Sensors can be arranged to track movements at the various joints in the robotic digit 100. In some examples, the sensors can be rotary encoders, which can be absolute or incremental encoders. Examples are illustrated herein with inductive encoders as sensors. The inductive encoder can include a sensor target (e.g., a printed circuit board with copper stripes arranged to provide a particular pitch) and an encoder that is responsive to movements of the sensor target. Other types of encoders (e.g., magnetic or optical encoders) can be used in other examples.

FIG. 3K illustrates a sensor target 252a mounted on the second flange portion 120b of the distal phalanx 112. FIG. 3F illustrates an encoder 252b attached to the proximal phalanx frame extension 122b. When the distal phalanx 112 is coupled to the proximal phalanx 110 as shown in, for example, FIG. 3L, the encoder 252b is positioned in opposing relation to the sensor target 252a and can detect relative movement of the sensor target 252a. A printed circuit board 125 can be mounted on a surface 123 (shown in FIG. 3F) of the proximal phalanx 110 as shown in FIG. 3L. The encoder 252b can be communicatively coupled to the printed circuit board 125. The sensor target 252a and encoder 252b can track relative movement between the distal phalanx 112 and the proximal phalanx 110.

FIG. 3B illustrates a sensor target 254a mounted on the distal first flange portion 142a of the metacarpal frame 140a. FIG. 3F illustrates an encoder 254b attached to the proximal phalanx frame 122a. When the proximal phalanx frame 122a is coupled to the metacarpal frame 140a as shown in FIG. 3I, the encoder 254b is in opposing relation to the sensor target 254a and can detect relative movement of the sensor target 254a. The encoder 254b can be communicatively coupled to the printed circuit board 125 (shown in FIG. 3L). The sensor target 254a and encoder 254b can track relative movement between the proximal phalanx 110 and the metacarpal 108.

FIG. 2C illustrates a sensor target 258a mounted on the CMC joint head 158. FIG. 3A illustrates an encoder 258b attached to the metacarpal frame extension 140b. When the CMC joint head 158 is coupled to the metacarpal 108 as shown in FIG. 3A, the encoder 258b is in opposing relation to the sensor target 258a and can detect relative movement of the sensor target 258a. The encoder 254b can be communicatively coupled to a printed circuit board 143 (shown in FIG. 3B) mounted on a surface 145 (shown in FIG. 3O) of the metacarpal frame 140a. The sensor target 258a and encoder 258b can track relative movement between the CMC joint head 158 and the metacarpal 108.

FIG. 2E illustrates a sensor target 260a mounted on the plate 190b attached to the oppose output 180. An encoder 260b is coupled to the CMC joint head 158. When the CMC joint head 158 is supported by the bearing 188 inside the oppose output 180 as shown in FIG. 2F, the encoder 260b is in opposing relation to the sensor target 260a and can detect relative movement of the sensor target 260a. The encoder 260b can be communicatively coupled to the printed circuit board 143 (shown in FIG. 3B) on the metacarpal body 140a. The sensor target 260a and encoder 260b can track relative movement between the CMC joint head 158 and the CMC oppose output 180.

FIG. 2D illustrates a position of a sensor target 262a when mounted on the oppose plate 202a (shown in FIG. 2C). An encoder 262b is coupled to the base arm 194a. When the oppose plate 202a is attached to the digit base frame extension 194a and oppose output 180 as shown in FIG. 2C, the encoder 262b is in opposing relation to the sensor target 262a. The encoder 262a can be communicatively coupled to the printed circuit board 143 (shown in FIG. 3B) on the metacarpal frame 140a. The sensor target 262a and encoder 262b can track relative movement between the CMC oppose output 180 and the base arm 194a.

The printed circuit boards 125, 143 can allow local processing of sensor data from the encoders (e.g., prior to transmitting the data to a main controller on a robotic hand). In some examples, the printed circuit boards 125, 143 can distribute power to the encoders.

### Example IV—Robotic Hand

FIG. 4A illustrates a robotic hand 400 including the robotic digit 100 (see Example II) as a first robotic digit (or thumb). The robotic hand 400 includes a second robotic digit 402a, a third robotic digit 402b, a fourth robotic digit 402c, and a fifth robotic digit 402d (which can, for example, have the structures described in U.S. Provisional Application No. 63/342,414 (“Systems, Devices, and Methods for a Robotic Joint”). The robotic digits 100, 402a-d are connected to a palm 404. The palm 404 can include an interface 406 that allows the robotic hand 400 to be connected to a robotic arm (e.g., to a wrist connection interface of the robotic arm).

In some examples, the robotic hand 400 can include a plate 408 mounted to a side of the palm 404 and carrying quick couplings for a hydraulic tube bundle 410. The hydraulic tube bundle 410 can include hydraulic lines (or tubes) 412 extending through paths in the palm 404 to various ports of the various hydraulic actuators in the robotic digits. In some examples, the hydraulic tubes 412 can pass through joints in the digits. For example, the hydraulic tubes 412 that supply fluid to the actuators in the robotic digit 100 (see Example II) can pass through the CMC joint 106.

In some examples, a printed circuit board 414 can be mounted on the palm 404 and include various circuitry for operation of the robotic hand 400. In some examples, the printed circuit board 414 can include a controller that communicates with the printed circuit boards 125, 143 on the robotic digit 100.

FIG. 4B illustrates a spatial pose of the robotic digit 100 after actuation of the CMC joint 106 using only the first CMC joint actuator 203 (in FIG. 2C). In FIG. 4B, the first CMC joint actuator 203 has been operated such that the robotic digit 100 is deflected downwards (relative to the drawing) and into opposing relation with the second robotic digit 402a. The spatial pose shown in FIG. 4B corresponds to the opposition movement illustrated in FIG. 3N.

FIG. 4C illustrates a spatial pose of the robotic digit 100 after actuation of the CMC joint 106 using only the second CMC joint actuator 218. In FIG. 4C, the second CMC joint actuator 218 (in FIG. 2C) has been operated such that the digit body 104 of the robotic digit 100 is rotated relative to a midline of the digit base 102. The spatial pose shown in FIG. 4C corresponds to the abduction movement illustrated in FIG. 3O.

FIG. 4D illustrates a spatial pose of the robotic digit 100 after actuation of the MCP joint 114 using the MCP joint actuator 146 (in FIG. 3J). In FIG. 4D, the MCP joint actuator 146 has been operated such that the angle between the metacarpal 108 and the proximal phalanx 110 is reduced (e.g., flexion of the digit body 104) from the neutral position, tilting the proximal phalanx 110 towards the second robotic digit 402a. The movement shown in FIG. 4D is in addition to the movement shown in FIG. 4B.

FIG. 4E illustrates a spatial pose of the robotic digit 100 after actuation of the CMC joint 106 using both of the first CMC joint actuator 203 (in FIG. 2C) and the second CMC joint actuator 218 (in FIG. 2C) and actuation of the MCP joint 114 using the MCP joint actuator 146 (in FIG. 3J). The spatial pose of the robotic digit 100 in FIG. 4E is a combination of the spatial poses shown in FIGS. 4B-4D.

FIGS. 4B-4E illustrate examples of spatial poses of the robotic digit 100, but the examples are not exhaustive. Any combination of actuation of the CMC joint 106, MCP joint 114, and IP joint 116 (as described in Example II) can be used to position the robotic digit 100 in any desired spatial pose (e.g., thumb opposition with any of the robotic digits on the robotic hand).

### Example IV—Tube Spring

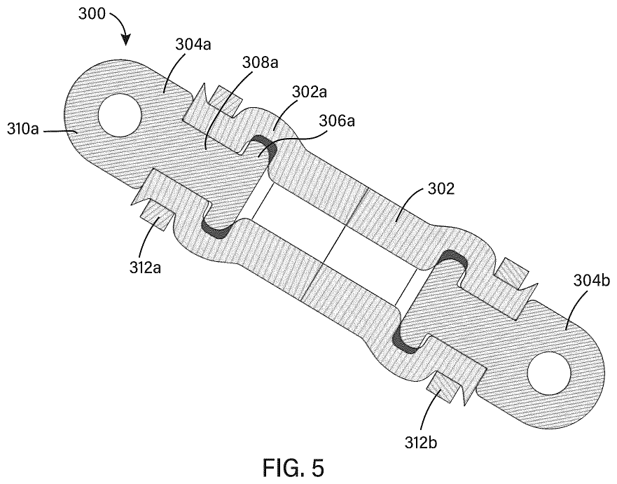

FIG. 5 illustrates a tube spring 300 that could be used as the bias members 138, 156 (in FIG. 3H) of the robotic digit 100 (see Example II).

In one example, the tube spring 300 can include a tube 302 formed of a resilient material (e.g., an elastomer). The tube spring 300 can include a first clip 304a and a second clip 304b coupled to opposite ends of the tube 302. The clips 304a, 304b can be used to attach the tube spring 300 to structures. In one example, the first clip 304a can have a base portion 306a, a neck portion 308a, and a head portion 310a. The neck portion 308a has a diameter that is smaller than a diameter of either of the base portion 306 and the head portion 310a. The base portion 306a and head portion 310a can be inserted into a first end portion 302a of the tube 302. The first end portion 302a of the tube 302 can be deformed around the base portion 306a and neck portion 308a to couple the first clip 304a to the tube 302. The head portion 310a of the first clip 304a protrudes from the tube 302 and is available for attaching the tube spring 300 to a structure. A retaining ring 312a can be disposed around the first end portion of the tube 302 in a region corresponding to the neck portion 308a of the first clip 304a to secure the first clip 304a at the first end portion 302a. The second clip 304b can have a similar structure to the first clip 304a and can be coupled to the second end portion of the tube 302 and secured using a retaining ring 312b in the same manner described for the first clip 304a.

### Example V—Robotic Digit

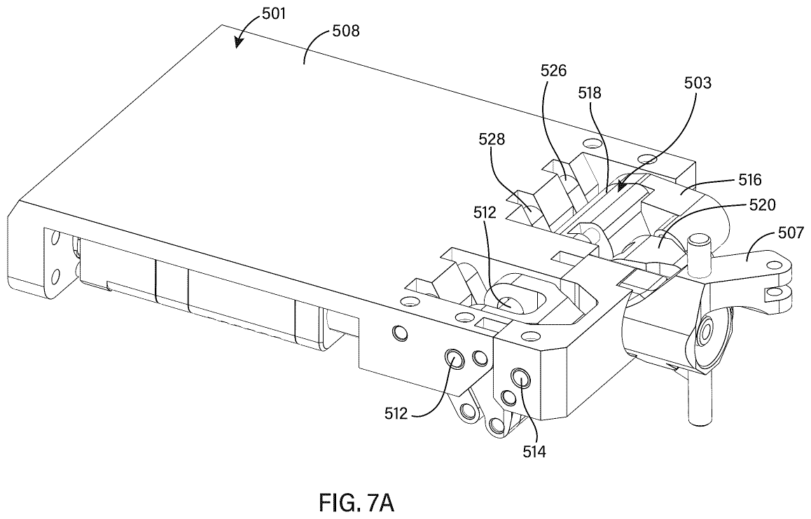

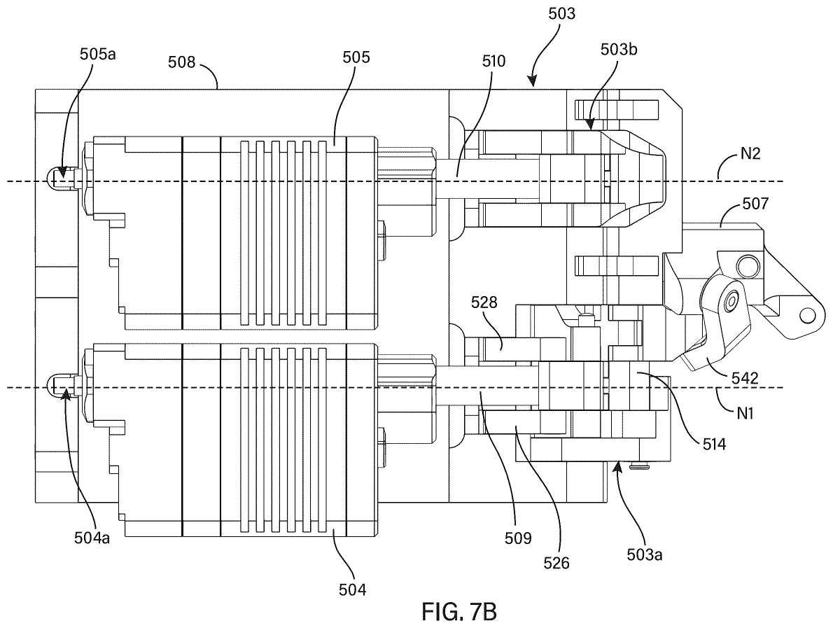

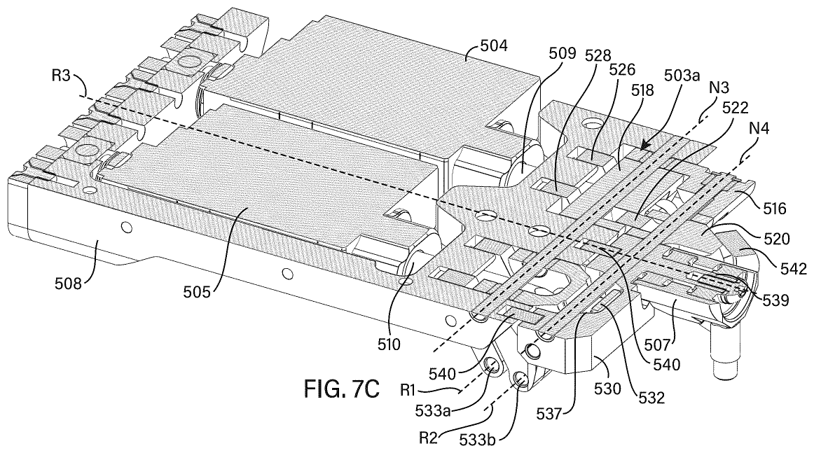

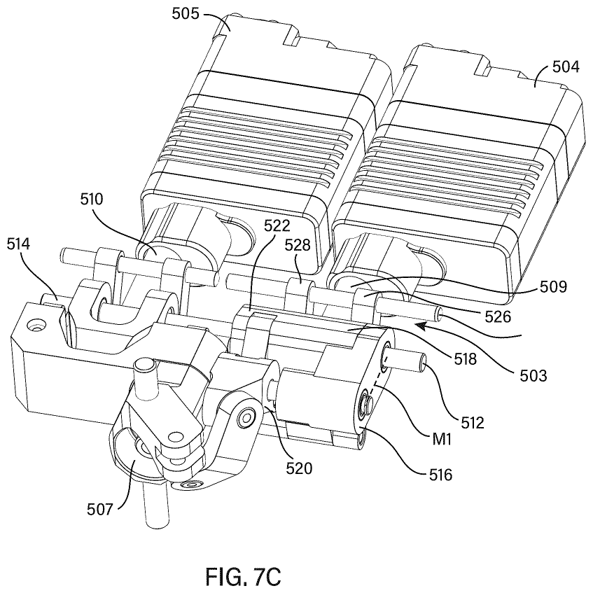

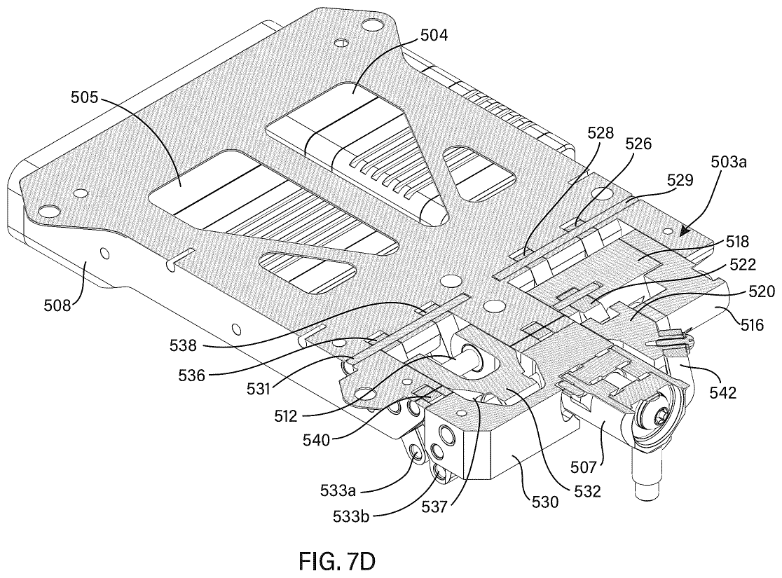

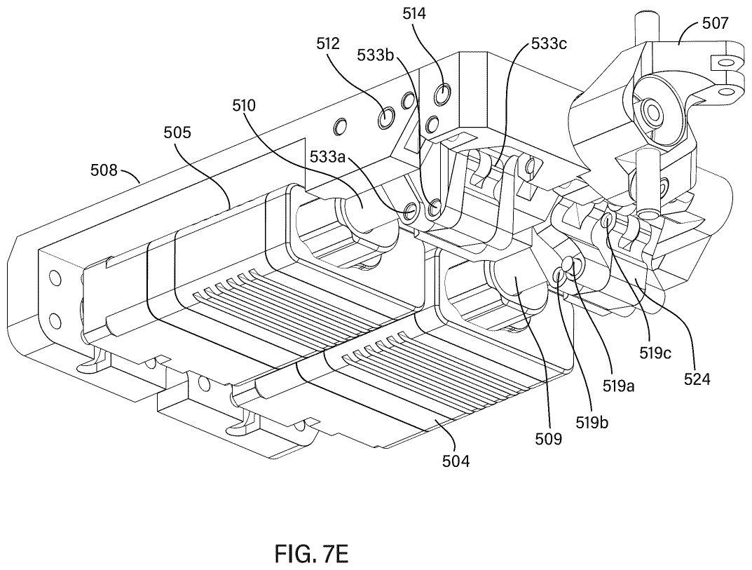

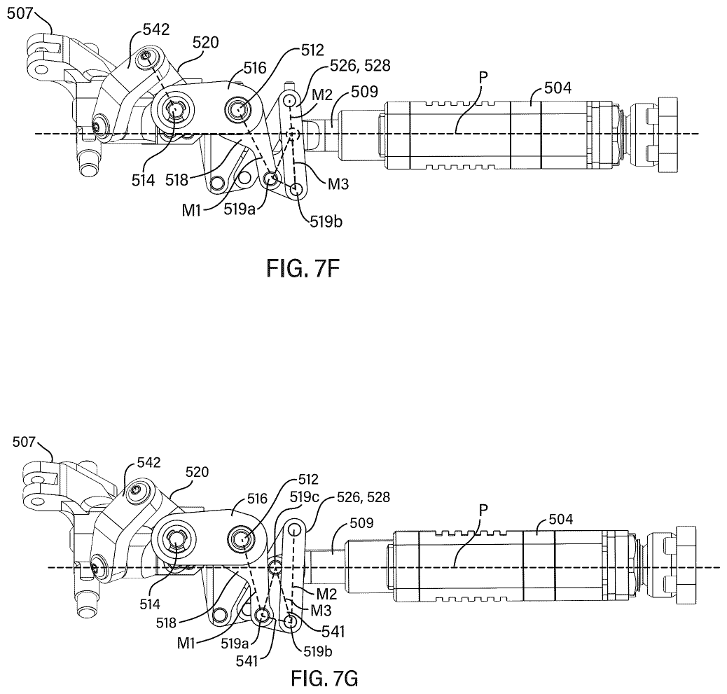

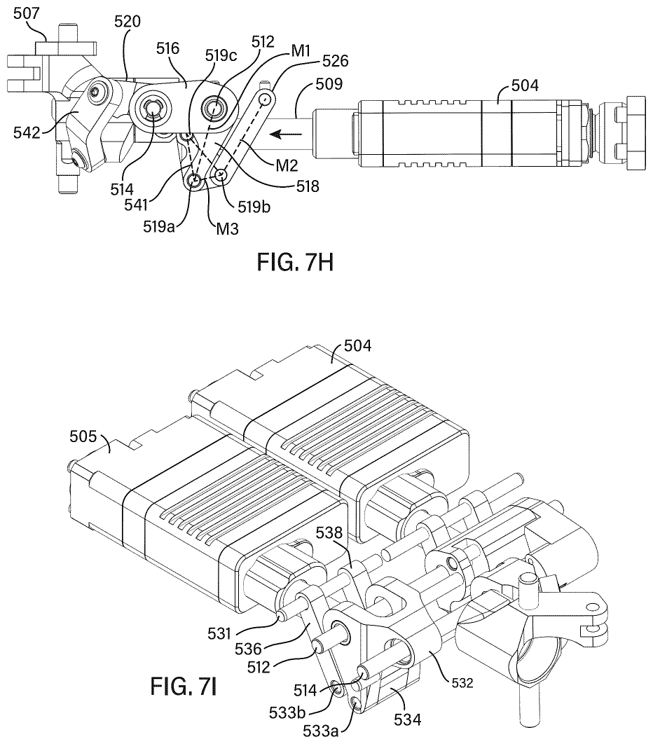

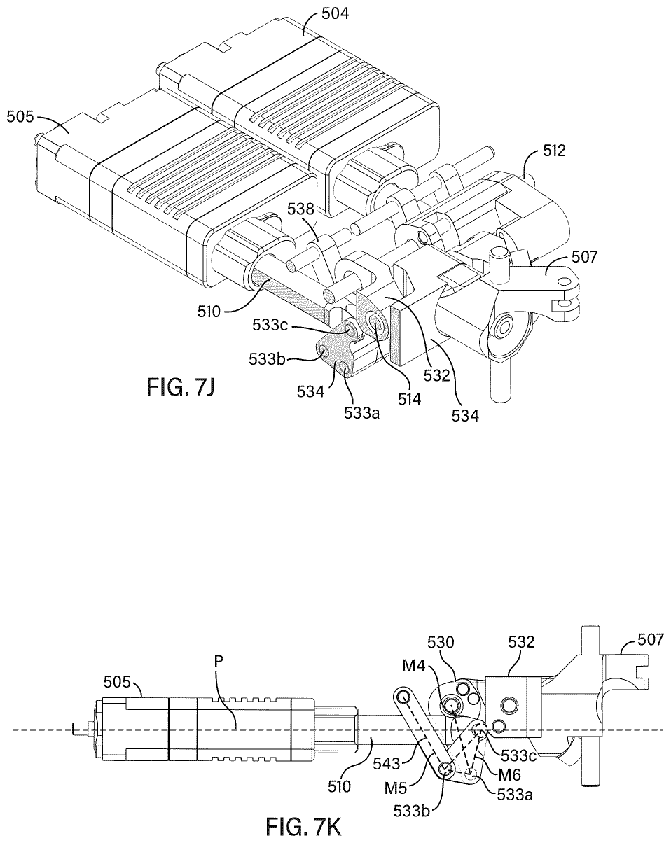

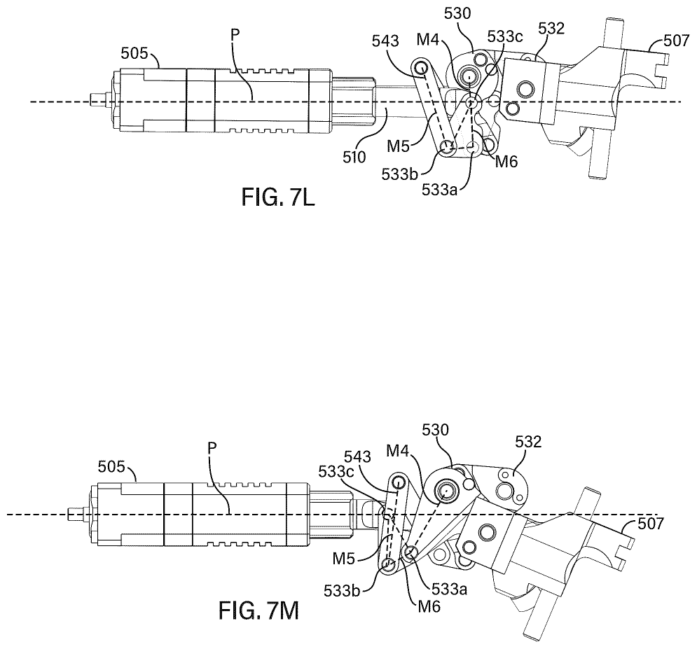

FIGS. 6A and 6B illustrate another example robotic digit 500 including a digit base 501 and a digit body 502 coupled to the digit base 501 through a CMC joint 503. The CMC joint 503 has multiple DOFs (e.g., abduction-adduction, opposition, and flexion-extension). The digit base 501 includes two actuators 504, 505 (see FIG. 6B). The CMC joint 503 includes a CMC joint head 507 coupled to the digit body 502. The CMC joint 503 uses a pair of straight line motion linkage systems (see FIGS. 7F-7H) to couple the outputs of the actuators 504, 505 to oppose and abduction movements of the CMC joint head 507. The outputs of the actuators 504, 505 are transferred to the CMC joint head 507 without use of gears, which can allow the CMC joint to be more compact (e.g., compared to the CMC joint of the robotic digit 100 that uses gears).

Referring to FIGS. 7A-7D, the digit base assembly 101 includes a digit base frame 508 to which the housings of the actuators 504, 505 are coupled (e.g., via couplings 504a, 505b). The couplings between the actuators 504, 505 and the digit base frame 508 can allow for some tilting of the actuators 504, 505 relative to a plane of the digit base frame 508 as the actuators are operated to effect opposition or abduction-adduction movements. The actuator 504 includes an actuator output shaft 509 having an axial axis N1 and can be operated to translate the actuator output shaft 509 in a direction along the axial axis N1. The actuator 505 includes an actuator output shaft 510 having an axial axis N2 and can be operated to translate the actuator output shaft 510 in a direction along the axial axis N2. The actuators 504, 505 are arranged such that the axial axes N1, N2 are parallel to each other. The actuators 504, 505 can be any type of linear actuator and can be powered by any suitable method (e.g., electric, hydraulic, or pneumatic).

The CMC joint 503 includes a CMC input shaft 512 mounted on the digit base frame 508 (e.g., by inserting end portions of the CMC input shaft 512 in holes in the digit base frame 508 as shown in FIG. 7C). The axial axis N3 of the input shaft 512 is transverse to the axial axes N1, N2 (shown in FIG. 7B) of the actuator output shafts 509, 510. The CMC joint 503 includes a CMC output shaft 514 that is laterally spaced from the CMC input shaft 512. The axial axis N4 of the CMC output shaft 514 is arranged in parallel to the axial axis N3 of the CMC input shaft 512. One end portion of the CMC output shaft 514 is retained on an abduct biscuit 516 (shown in FIG. 7B) that is pivotally mounted on the CMC input shaft 512 as further described herein.

The CMC joint abduction 503a can include an abduct biscuit 516 having a first portion mounted on the CMC input shaft 512 and rotatable relative to the CMC input shaft 512 and a second portion including an opening receiving an end portion of the CMC output shaft 514. The CMC output shaft 514 can be retained relative to the abduct biscuit 516 (as shown in FIG. 7C) such that rotation of the first portion of the abduct biscuit 516 relative to the CMC input shaft 512 about the axial axis N3 can result in movement of the CMC output shaft 514 (e.g., rotation of the CMC output shaft 514 about the axial axis N3 of the CMC input shaft 512).

The CMC joint abduction mechanism 503a can include an abduct input arm 518 mounted on the CMC input shaft 512 and rotatable relative to the CMC input shaft 512 about the axial axis N3. The CMC joint abduction 503a can include an abduct output arm 520 mounted on the CMC output shaft 514 and rotatable relative to the CMC output shaft 514. An abduct inner link 522 (shown in FIGS. 7C and 7D) has its opposite ends pivotally coupled to the abduct input arm 518 and the abduct output arm 520 such that rotation of the abduct input arm 518 about the CMC input shaft 512 can cause rotation of the abduct output arm 520 about the CMC output shaft 514. A spherical linkage 542 coupling the abduct output arm 520 to the CMC joint head 507 transfers rotation of the abduct output arm 520 to the CMC joint head 507.

Referring to FIGS. 7D-7G, the CMC joint abduction mechanism 503a can include linkage arms 526, 528 pivotally coupled to the digit base frame 508 (e.g., via a rod 529 that can be inserted in openings in the digit base frame 508 as shown in FIG. 7D). The CMC joint abduction mechanism 503a can include a CMC input link 524 pivotally coupled to the abduct input arm 518 at a first pivot joint 519a, pivotally coupled to the linkage arms 526, 528 at a second pivot joint 519b, and pivotally coupled to the actuator output shaft 509 at a third pivot joint 519c (see FIG. 7E).

Referring to FIGS. 7F-7H, a straight line motion linkage 541 is formed by link M1 corresponding to the portion of the abduct input arm 518 supported on the CMC input shaft 512 and coupled to the pivot joint 519a, link M2 corresponding to the paired linkage arms 526, 528 link M3 corresponding to the CMC input link 524. Link M3 is a triangle having the pivot joints 519a, 519b, 519c as nodes. Linear movement of the actuator output shaft 509 causes displacement of the pivot joint 519c approximately in a straight line P, which causes rotation of the triangle link M3 about the pivot joint 519c (or rotation of the pivot joints 519a, 519b about different circles centered at pivot joint 519c). Rotation of the pivot joints 519a, 519b causes rotation of the abduct input arm 518 (link M1) and rotation of the paired linkages 526, 528 (link M2). Displacement of the pivot joint 519c causes double rotation of the abduct input arm 518 about axes extending through the pivot joints 519a, 519b and parallel to the CMC input shaft 512 (in a similar manner described in Example II and FIG. 2H). Rotation of the abduct input arm 518 is transferred to pivoting of the abduct output arm 520 on the CMC output shaft 514 via the abduct inner link 522 (shown in FIG. 7C). A spherical linkage 542 coupling the abduct output arm 520 to the CMC joint head 507 converts rotation of the abduct output arm 520 to rotation of the CMC joint head 507 (or abduction movement of the CMC joint 503). Abduction movement is rotation of the CMC joint head 507 about axis R3 (shown in FIG. 7C). Axis R3 can be transverse to the CMC output shaft axis N4. There can be slight deviations in movement of the pivot joint 519c in the straight line P, but the deviations can be kept very small (e.g., to no more than 1 degree by appropriate modeling of the geometry of the linkage 541).

Referring to FIGS. 71 and 7J, the CMC joint opposition mechanism 503b can include an oppose biscuit 532 having a first portion mounted on the CMC input shaft 512 and a second portion mounted on the CMC output shaft 514. The CMC joint opposition mechanism 503b can include paired linkage arms 536, 538 pivotally coupled to the digit base frame 508 (e.g., via a rod 531 that can be inserted in openings in the digit base frame 508 as shown in FIG. 7D). The CMC joint opposition mechanism 503b can include a CMC input link 534 (similar to the CMC input link 524 of the CMC joint opposition mechanism 503a) pivotally coupled to the oppose biscuit 532 at a first pivot joint 533a, pivotally coupled to the linkage arms 536, 538 at a second joint 533b, and pivotally coupled to the actuator output shaft 510 at a third pivot joint 533c (also, see FIG. 7E).

Referring to FIG. 7C, the CMC joint opposition mechanism 503b can include an oppose output 530 pivotally coupled to the digit base frame 508 by oppose inner links 540 and having a bore receiving a portion of the CMC output shaft 514. The oppose output 530 is positioned generally in opposing relation to the oppose biscuit 532 and includes a recess 537 that accommodates the second portion of the oppose biscuit 532 mounted on the CMC output shaft 514. The CMC joint head 507 is mounted to a fixed shaft 539 of the oppose output 530 so that movement of the oppose output 530 about or with the CMC output shaft 514 can be transferred to the CMC joint head 507.

Referring to FIGS. 7K-7M, a straight line motion linkage 543 is formed by link M4 corresponding to the portion of the oppose biscuit 532 supported on the CMC input shaft 512 and coupled to the pivot joint 533a, link M5 corresponding to the paired linkage arms 536, 538, and link M6 corresponding to the CMC input link 534. Link M6 is a triangle having the pivot joints 533a, 533b, 533c as nodes. Linear movement of the actuator output shaft 510 causes displacement of the pivot joint 533c approximately in a straight line P, which causes rotation of the triangle link M6 about the pivot joint 533c (or rotation of the pivot joints 533a, 533b about different circles centered at pivot joint 533c). Rotation of the pivot joints 533a, 533b causes rotation of the oppose biscuit 532 (link M4) and rotation of the paired linkages 536, 538 (link M5). Displacement of the pivot joint 533c causes double rotation of the oppose biscuit 532 about axes extending through the pivot joints 522a, 522b and parallel to the CMC input shaft 512 (in a similar manner described in Example II and FIG. 2H). Rotation of the oppose biscuit 532 is transferred to rotation of the output shaft 514 and oppose output 530. Since the CMC joint head 507 is coupled to the oppose output 507, the rotation of the oppose output 530 is converted to rotation (or opposition movement) of the CMC joint head 507. The opposition movement is about axis R1 and/or axis R2 (shown in FIG. 7C). Axes R1, R2 are parallel to CMC output shaft axis N4 or CMC input shaft axis N3. Axis R1 extends through pivot joint 533a, and axis R2 extends through pivot joint 533b. Axes R1, R2 are transverse to axis R3. There can be slight deviations in movement of the pivot joint 533c in the straight line P, but the deviations can be kept very small (e.g., to no more than 1 degree by appropriate modeling of the geometry of the linkage 543).

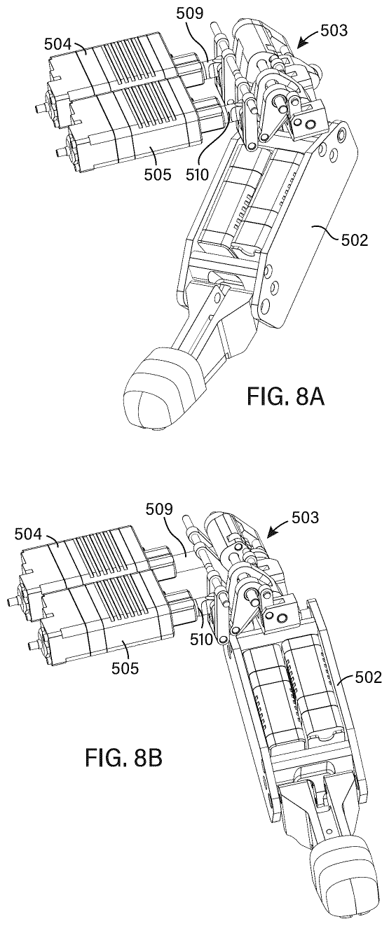

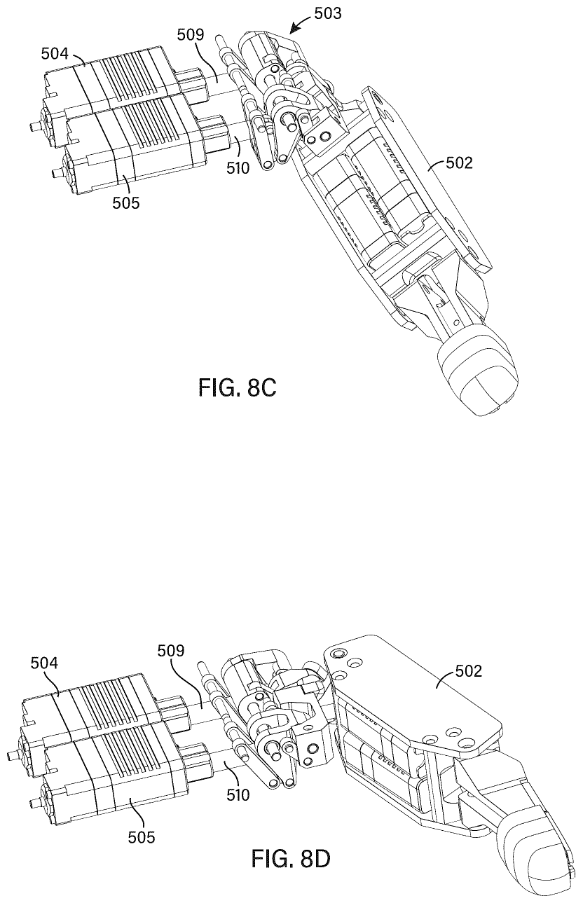

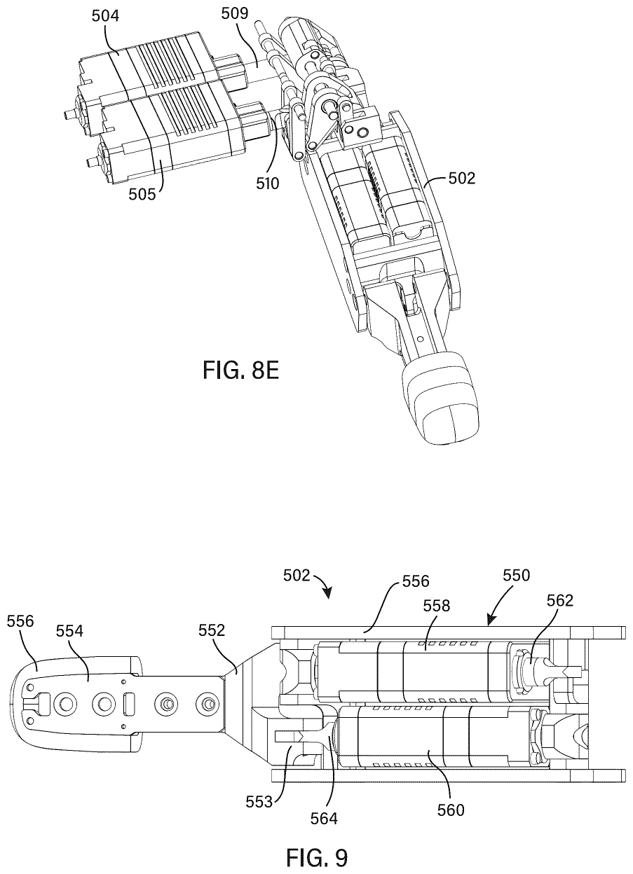

FIG. 8A shows examples of configurations of the robotic digit. The digit base frame 508 is hidden to allow better view of the positions of the actuator output shafts 509, 510. In FIG. 8A, both actuator output shafts 509, 510 are retracted. In FIG. 8B, the actuator output shaft 509 is extended, while the actuator output shaft remains substantially retracted (corresponding to pure abduction movement). In FIG. 8C, both actuator output shafts 509, 510 are extended, but the actuator output shaft 509 extends further than the actuator output shaft 510. In FIG. 8D, both actuator output shafts are extended by roughly equal amounts. In FIG. 8E, the actuator output shaft is retracted, while the actuator output shaft is extended (corresponding to pure opposition movement).

Referring to FIGS. 9 and 6A, the digit body 502 includes a metacarpal 550, a proximal phalanx 552 coupled to the metacarpal 550 by a MCP joint 553, and a distal phalanx 554 coupled to the proximal phalanx 552. The metacarpal 550 includes a metacarpal frame 556, a third actuator 558, and a fourth actuator 560. The housings of the actuators 558 and 560 can be coupled to the metacarpal frame 556 in a manner that allows the actuators 558 and 560 to be tiltable relative to the metacarpal frame 556. The CMC joint head 507 can be pivotally coupled to the metacarpal 550. The third actuator 558 includes an actuator output shaft 562 that can be coupled to the CMC joint head 507 and extended/retracted for flexion-extension movement of the CMC joint. The fourth actuator 560 includes an actuator output shaft 564 that can be coupled to the MCP joint 553 and extended/retracted for flexion-extension movement of the proximal phalanx 552. In this example, the distal phalanx 554 can be fixed to the proximal phalanx 552 to reduce the complexity of the robotic digit. A tactile sensor 556 can be mounted on the distal phalanx 554.

Returning to FIGS. 6A and 6B, the robotic digit 500 can incorporate a sensor system as described in Example III. The robotic digit 500 can be incorporated in a robotic hand. For example, the robotic digit 500 can be substituted for the robotic digit 100 of the robotic hand 400 shown in FIG. 4A.

### Additional Examples

Additional examples based on principles described herein are enumerated below. Further examples falling within the scope of the subject matter can be configured by, for example, taking one feature of an example in isolation, taking more than one feature of an example in combination, or combining one or more features of one example with one or more features of one or more other examples.
Example 1.1: A robotic digit comprises a base member, a joint head movably coupled to the base member, an articulated body member movably coupled to the joint head, a first actuator having a first actuator output coupled to the joint head, a second actuator having a second actuator output coupled to the joint head, a third actuator having a third actuator output coupled to the joint head, wherein the first actuator output causes a first relative movement between the joint head and the base member, wherein the second actuator output causes a second relative movement between the joint head and the base member that is different from the first relative movement, and wherein the third actuator output causes a third relative movement between the joint head and the articulated body.
Example 1.2: The robotic digit according to Example 1.1, wherein the first actuator output is coupled to the joint head by a first mechanical linkage, and wherein the second actuator output is coupled to the joint head by a second mechanical linkage.
Example 1.3: The robotic digit according to Example 1.2, wherein the first mechanical linkage comprises an output member having a first gear portion, a base arm extending from the base member and having a second gear portion engaged with the first gear portion, and a link member having a first end coupled to the first actuator output and a second end pivotably coupled to each of the output member and the base arm, wherein the link member is pivotable relative to the output member about a first axis and pivotable relative to the base arm about a second axis parallel to the first axis.
Example 1.4: The robotic digit according to Example 1.2, wherein the first mechanical linkage comprises an output member having a first pair of gear portions disposed on opposite sides of the output member; a pair of base arms coupled to the base member and extending in a direction towards the first pair of gear portions, the pair of base arms having a second pair of gear portions engaged with the first pair of gear portions; and a link member having a first end coupled to the first actuator output and a second end pivotably coupled to each of the output member and the pair of base arms, wherein the link member is pivotable relative to the output member about a first axis and pivotable relative to the pair of base arms about a second axis parallel to the first axis.
Example 1.5: A robotic digit according to Example 1.4, wherein the joint head is rotatably coupled to the output member, wherein the joint head is pivotable with the output member about the first axis and the second axis, and wherein the joint head is rotatable relative to the output member about a third axis transverse to the first and second axes.
Example 1.6: A robotic digit according to Example 1.5 further comprises a first sensor target coupled to one of the output member and the joint head; and a first encoder coupled to the other of the output member and the joint head in opposing relation to the first sensor target, wherein the first encoder is configured to sense a relative movement of the first sensor target.
Example 1.7: A robotic digit according to any one of Examples 1.5-1.6, wherein the second mechanical linkage is configured to rotate the joint head about the third axis in response to the second actuator output.
Example 1.8: A robotic digit according to Example 1.7, wherein the second mechanical linkage comprises an input arm coupled to the second actuator output, the input arm having a first gear portion; an output arm having a second gear portion engaged with the first gear portion of the input arm; and a spherical linkage having a first end coupled to the output arm and a second end coupled to the joint head.
Example 1.9: A robotic digit according to Example 1.8, wherein the input arm and output arm are disposed parallel to the pair of base arms.
Example 1.10: A robotic digit according to Example 1.9, wherein the output arm is pivotally coupled to the output member.
Example 1.11: A robotic digit according to any one of Examples 1.8-1.10 further comprises a second target coupled to one of the output member and the joint head; and a second encoder coupled to the other of the output member and the joint head in opposing relation to the second sensor target, wherein the second encoder is configured to sense a relative movement of the second sensor target.
Example 1.12: A robotic digit according to any one of Examples 1.2-1.11, wherein the first actuator comprises a first hydraulic cylinder, wherein the second actuator comprises a second hydraulic cylinder, and wherein the third actuator comprises a third hydraulic cylinder.
Example 1.13: A robotic digit according to Example 1.12, wherein the first hydraulic cylinder comprises a first piston shaft coupled to a first piston, wherein the first piston is disposed within a first bore formed in the base member, and wherein the first piston shaft is coupled to the first mechanical linkage.
Example 1.14: A robotic digit according to Example 1.12, wherein the second hydraulic cylinder includes a second piston shaft coupled to a second piston, wherein the second piston is disposed within a second bore formed in the base member, and wherein the second piston shaft is coupled to the second mechanical linkage.
Example 1.15: A robotic digit according to Example 1.12, wherein the third hydraulic cylinder includes a third piston shaft coupled to a third piston, wherein the third piston is disposed within a third bore formed in the articulated body member, and wherein the third piston shaft is coupled to the joint head.
Example 1.16: A robotic digit according to Example 1.15, wherein the first hydraulic cylinder, the second hydraulic cylinder, and the third hydraulic cylinders are double-acting hydraulic cylinders.
Example 1.17: A robotic digit according to any one of the Examples 1.1-1.16, wherein the articulated body member comprises a first link member pivotally coupled to the joint head, and wherein the third actuator causes the third relative movement between the first link member and the joint head.
Example 1.18: A robotic digit according to Example 1.17 further comprises a third sensor target coupled to one of the joint head and the first link member; and a third encoder coupled to the other of the joint head and the first link member in opposing relation to the third sensor target, wherein the third encoder is configured to sense a relative movement of the third sensor target.
Example 1.19: A robotic digit according to any one of Examples 1.17-1.18, wherein the articulated body member comprises a second link member pivotally coupled to the first link member; and a fourth actuator having a fourth actuator output coupled to the second link member, wherein the fourth actuator output causes a fourth relative movement between the first link member and the second link member.
Example 1.20: A robotic digit according to Example 1.19, wherein the fourth actuator comprises a fourth hydraulic cylinder including a fourth piston shaft coupled to a fourth piston, wherein the fourth piston is disposed in a bore formed in the first link member, and wherein the fourth piston shaft is coupled to the second link member.
Example 1.21: A robotic digit according to Example 1.19, wherein the fourth hydraulic cylinder is a single-acting hydraulic cylinder, and further comprising a first bias member coupled to the first link member and the second link member and configured to return a stroke of the fourth hydraulic cylinder.
Example 1.22: A robotic digit according to any one of Examples 1.19-1.21 further comprises a fourth sensor target coupled to one of the first link member and the second link member; and a fourth encoder coupled to the other of the first link member and the second link member in opposing relation to the fourth sensor target, wherein the fourth encoder is configured to sense a relative movement of the fourth sensor target.
Example 1.23: A robotic digit according to any one of Examples 1.19-1.22, wherein the articulated body member comprises a third link member pivotally coupled to the second link member and forming a tip of the articulated body member; and a fifth actuator having a fifth actuator output coupled to the third link member, wherein the fifth actuator output causes a fifth relative movement between the third link member and the second link member.
Example 1.24: A robotic digit according to Example 1.23, wherein the fifth actuator comprises a fifth hydraulic cylinder including a fifth piston shaft coupled to a fifth piston, wherein the fifth piston is disposed in a bore formed in the second link member, and wherein the fifth piston shaft is coupled to the third link member.
Example 1.25: A robotic digit according to Example 1.24, wherein the fifth hydraulic cylinder is a single-acting hydraulic cylinder, and further comprising a second bias member coupled to the second link member and the third link member and configured to return a stroke of the fifth hydraulic cylinder.
Example 1.26: A robotic digit according to Example 1.23-1.25 further comprises a fifth sensor target coupled to one of the second link member and the third link member; and a fifth encoder coupled to the other of the second link member and the third link member in opposing relation to the fifth sensor target, wherein the fifth encoder is configured to sense a relative movement of the fifth sensor target.
Example 1.27: A robotic digit according to any one of Examples 1.1-1.26, wherein the joint head comprises a central opening for passage of hydraulic lines and electrical wires.
Example 2.1: A robotic digit comprises a base member; an articulated body comprising a first link member, a second link member, a third link member, a first joint formed between the first link member and the second link member, and a second joint formed between the second link member and the third link member, each of the first joint and the second joint having at least one degree of freedom; and a third joint coupling the base member to the articulated body, the third joint having at least three degrees of freedom.
Example 2.2: The robotic digit of Example 2.1, wherein the first, second, and third joints are hydraulically-actuated.
Example 3.1: A robotic hand comprises a robotic digit according to any one of Examples 1.1-1.27.
Example 4.1: A robotic digit comprises a digit base frame, a first actuator coupled to the digit base frame, the first actuator having a first actuator output shaft, a second actuator coupled to the digit base frame, the second actuator having a second actuator output shaft, a joint head, a digit body movably coupled to the joint head, a first output member coupled to the joint head, a second output member coupled to the joint head, a first straight line motion linkage coupling the first actuator output shaft to the first output member, wherein linear displacement of the first actuator output shaft causes a first rotational movement of the joint head through the first straight line motion linkage, and a second straight line motion linkage coupling the second actuator output shaft to the second output member, wherein linear displacement of the second actuator output shaft causes a second rotational movement of the joint head through the second straight line motion linkage, wherein the first rotational movement is different from the second rotational movement.
Example 4.2: The robotic digit according to Example 4.1, wherein the first straight line motion linkage comprises a first link member pivotally coupled to the digit base frame, a second link member pivotally coupled to the first output member, and a third link member having a first node coupled to the first link member, a second node coupled to the second link member, and a third node coupled to the first actuator output shaft. Linear displacement of the first actuator output shaft causes movement of the third node approximately in a straight line.
Example 4.3: The robotic digit according to Example 4.1, wherein the second straight line motion linkage comprises a first link member pivotally coupled to the digit base frame, a second link member pivotally coupled to the second output member, and a third link member having a first node coupled to the first link member, a second node coupled to the second link member, and a third node coupled to the second actuator output shaft. Linear displacement of the second actuator output shaft causes movement of the third node approximately in a straight line.
Example 4.4: The robotic digit according to Example 4.2, wherein the first output member is coupled to the joint head by a spherical linkage.

1. A robotic digit comprising:
a digit base frame;
a joint head;
an articulated digit body coupled to the joint head;
a first actuator mounted to the digit base frame, the first actuator having a first actuator output coupled to the joint head by a first mechanical linkage, wherein the first actuator output causes a first relative movement between the joint head and the digit base frame through the first mechanical linkage; and
a second actuator mounted to the digit base frame, the second actuator having a second actuator output coupled to the joint head by a second mechanical linkage, wherein the second actuator output causes a second relative movement between the joint head and the digit base frame that is different from the first relative movement through the second mechanical linkage.

2. The robotic digit of claim 1, further comprising a third actuator coupled to the articulated digit body, the third actuator having a third actuator output coupled to the joint head, wherein the third actuator output causes a third relative movement between the articulated body and the joint head.

3. The robotic digit of claim 2, further comprising a pair of digit base frame extensions arranged in parallel and coupled to opposite sides of the digit base frame, the pair of digit base frame extensions having a first pair of gear portions, and wherein the first mechanical linkage comprises:
an output member having a second pair of gear portions disposed on opposite sides of the output member and engaged with the first pair of gear portions; and
a link member having a first end coupled to the first actuator output and a second end pivotably coupled to each of the output member and the pair of digit base frame extensions, wherein the link member is pivotable relative to the output member about a first axis and pivotable relative to the pair of digit base frame extensions about a second axis parallel to the first axis.

4. The robotic digit of claim 3, wherein the joint head is rotatably coupled to the output member, wherein the joint head is pivotable with the output member about the first axis and the second axis, and wherein the joint head is rotatable relative to the output member about a third axis transverse to the first and second axes.

5. The robotic digit of claim 4, further comprising:
a first sensor target coupled to one of the output member and pair of digit base frame extensions; and
a first encoder coupled to the other of the output member and pair of digit base frame extensions and positioned in opposing relation to the first sensor target, wherein the first encoder is configured to sense a relative movement of the first sensor target.

6. The robotic digit of claim 4, wherein the second mechanical linkage is configured to rotate the joint head about the third axis, and wherein the second mechanical linkage comprises:
an input arm coupled to the second actuator output and disposed parallel to the pair of digit base frame extensions, the input arm having a first gear portion;
an output arm disposed parallel to the pair of digit base frame extensions and pivotally coupled to the output member, the output arm having a second gear portion engaged with the first gear portion of the input arm; and
a spherical linkage having a first end coupled to the output arm and a second end coupled to the joint head.

7. The robotic digit of claim 6, further comprising:
a second target coupled to one of the output member and the joint head; and
a second encoder coupled to the other of the output member and the joint head in opposing relation to the second sensor target, wherein the second encoder is configured to sense a relative movement of the second sensor target.

8. The robotic digit of claim 2, wherein the first actuator comprises a first hydraulic cylinder, wherein the second actuator comprises a second hydraulic cylinder, and wherein the third actuator comprises a third hydraulic cylinder.

9. The robotic digit of claim 8, wherein the first hydraulic cylinder comprises a first piston shaft coupled to a first piston, wherein the first piston is disposed within a first bore formed in the digit base frame, and wherein the first piston shaft is coupled to the first mechanical linkage;
wherein the second actuator comprises a second hydraulic cylinder, wherein the second hydraulic cylinder includes a second piston shaft coupled to a second piston, wherein the second piston is disposed within a second bore formed in the digit base frame, and wherein the second piston shaft is coupled to the second mechanical linkage; and
wherein the third hydraulic cylinder includes a third piston shaft coupled to a third piston, wherein the third piston is disposed within a third bore formed in the articulated digit body, and wherein the third piston shaft is coupled to the joint head.

10. The robotic digit of claim 8, wherein the first hydraulic cylinder, the second hydraulic cylinder, and the third hydraulic cylinders are double-acting hydraulic cylinders.

11. The robotic digit of claim 7, wherein the articulated digit body comprises a first link member pivotally coupled to the joint head, wherein the third actuator output causes the third relative movement between the first link member and the joint head, and further comprising:
a third sensor target coupled to one of the joint head and the first link member; and
a third encoder coupled to the other of the joint head and the first link member in opposing relation to the third sensor target, wherein the third encoder is configured to sense a relative movement of the third sensor target.

12. The robotic digit of claim 11, wherein the articulated digit body comprises:
a second link member pivotally coupled to the first link member; and
a fourth actuator having a fourth actuator output coupled to the second link member, wherein the fourth actuator output causes a fourth relative movement between the first link member and the second link member.

13. The robotic digit of 12, wherein the articulated body member comprises:
a third link member pivotally coupled to the second link member and forming a tip of the articulated digit body; and
a fifth actuator having a fifth actuator output coupled to the third link member, wherein the fifth actuator output causes a fifth relative movement between the third link member and the second link member.

14. The robotic digit of claim 13, wherein the fourth actuator comprises a fourth hydraulic cylinder including a fourth piston shaft coupled to a fourth piston, wherein the fourth piston is disposed in a bore formed in the first link member, and wherein the fourth piston shaft is coupled to the second link member; and
wherein the fifth actuator comprises a fifth hydraulic cylinder including a fifth piston shaft coupled to a fifth piston, wherein the fifth piston is disposed in a bore formed in the second link member, and wherein the fifth piston shaft is coupled to the third link member.

15. The robotic digit of claim 14, wherein the fourth hydraulic cylinder is a single-acting hydraulic cylinder, and further comprising a first bias member coupled to the first link member and the second link member and configured to return a stroke of the fourth hydraulic cylinder, and
wherein the fifth hydraulic cylinder is a single-acting hydraulic cylinder, and further comprising a second bias member coupled to the second link member and the third link member and configured to return a stroke of the fifth hydraulic cylinder.

16. The robotic digit of claim 12, further comprising:
a fourth sensor target coupled to one of the first link member and the second link member;
a fourth encoder coupled to the other of the first link member and the second link member and positioned in opposing relation to the fourth sensor target, wherein the fourth encoder is configured to sense a relative movement of the fourth sensor target;
a fifth sensor target coupled to one of the second link member and the third link member; and
a fifth encoder coupled to the other of the second link member and the third link member and positioned in opposing relation to the fifth sensor target, wherein the fifth encoder is configured to sense a relative movement of the fifth sensor target.

17. The robotic digit of claim 1, wherein the joint head comprises a central opening for passage of line structures.

18. A robotic digit comprising:
a digit base frame;
a first actuator coupled to the digit base frame, the first actuator having a first actuator output shaft;
a second actuator coupled to the digit base frame, the second actuator having a second actuator output shaft;
a joint head;
a digit body coupled to the joint head;
a first output member coupled to the joint head;
a second output member coupled to the joint head;
a first straight line motion linkage coupling the first actuator output shaft to the first output member, wherein linear displacement of the first actuator output shaft causes a first rotational movement of the joint head through the first straight line motion linkage; and
a second straight line motion linkage coupling the second actuator output shaft to the second output member, wherein linear displacement of the second actuator output shaft causes a second rotation of the joint head through the second straight line motion linkage, wherein the second rotational movement is different from the first rotational movement.

19. The robotic digit of claim 18, wherein the first straight line motion linkage comprises a first link member pivotally coupled to the digit base frame, a second link member pivotally coupled to the first output member, and a third link member having a first node coupled to the first link member, a second node coupled to the second link member, and a third node coupled to the first actuator output shaft, wherein linear displacement of the first actuator output shaft causes movement of the third node approximately in a straight line.

20. The robotic digit of claim 19, wherein the first output member is coupled to the joint head by a spherical linkage.
